(19) United States
(12) Patent Application Publication
(10) Pub. No.: US 2009/0143273 A1
(43) Pub. Date: Jun. 4, 2009

(54) Hard Surface Cleaning and Disinfecting Compositions

(75) Inventor: Tak Wai CHEUNG, Yuma, AZ (US)

Correspondence Address: NORRIS, MCLAUGHLIN & MARCUS, 875 THIRD AVE, 18TH FLOOR, NEW YORK, NY, 10022, US

(73) Assignee: Reckitt Benckiser Inc., Parsippany, NJ (US)

(21) Appl. No.: 12/367,053

(22) Filed: Feb. 6, 2009

Related U.S. Application Data
(62) Division of application No. 10/494,544, filed on Apr. 27, 2004.

(30) Foreign Application Priority Data
Nov. 2, 2001 (GB) 0126347.4

(51) Int. Cl. C11D 3/48; C11D 3/37

(52) U.S. Cl. 510/391; 510/475

(57) ABSTRACT

Hard surface cleaning and disinfecting compositions comprising cationic surfactants having germicidal properties, fluorosurfactant compounds, film-forming polymers and, optionally, detersive surfactants and or organic solvents. The hard surface cleaning and disinfecting compositions provide excellent cleaning and disinfection of hard surfaces.

The present invention relates to hard surface cleaning and disinfecting compositions which comprise a combination of a quaternary ammonium compound, a fluorosurfactant compound, and a film-forming compound.

The prior art has suggested many aqueous compositions which are directed to provide a cleaning or disinfecting benefit to such hard surfaces. These compositions predominantly are aqueous preparations which include one or more detersive surfactants, one or more organic solvents and in minor amounts, conventional additives included enhance the attractiveness of the product, typically fragrances and coloring agents. Certain of these also include one or more constituents which provide a primary disinfecting benefit to the aqueous preparations.

While these known-art compositions may provide advantages, there is a continuing need in the art for such hard surface treatment compositions which include reduced amounts of active constituents, and which minimize or eliminate the amounts of organic solvents which need be present in such compositions.

It is yet a further object of the invention to provide a readily pourable and readily pumpable cleaning composition which features the benefits described above.

It is a further object of the invention to provide a process for cleaning or sanitization of hard surfaces, which process comprises the step of: providing the composition as outlined above, and applying an effective amount to a hard surface requiring such treatment. The compositions of the present invention may also provide some residual sanitizing activity.

These and other objects of the invention shall be more apparent from a reading of the specification and of the claims attached.

The invention provides a hard surface cleaning and disinfecting composition which comprises (preferably, consisting essentially of) the following constituents:
(a) at least one cationic surfactant having germicidal properties;
(b) a fluorosurfactant selected from the group of nonionic fluorosurfactants, cationic fluorosurfactants, perfluoroalkylethyl fluorosurfactants, and mixtures thereof;
(c) a film-forming polymer selected from the group consisting of
   (1) polymer having the formula

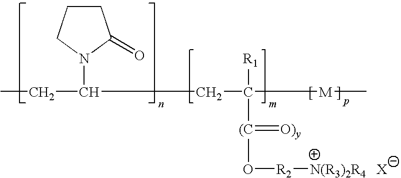

in which n represents from 20 to 99 and preferably from 40 to 90 mol %, m represents from 1 to 80 and preferably from 5 to 40 mol %; p represents 0 to 50 mol, (n+m+p=100); R₁ represents H or CH₃; y represents 0 or 1; R₂ represents —CH₂—CHOH—CH₂— or CₓH₂ₓ in which x is 2 to 18; R₃ represents CH₃, C₂H₅ or t-butyl; R₄ represents CH₃, C₂H₅ or benzyl; X represents Cl, Br, I, ½SO₄, HSO₄ and CH₃SO₃; and M is a vinyl or vinylidene monomer copolymerisable with vinyl pyrrolidone other than the monomer identified in [ ]ₘ.
(2) water soluble polyethylene oxide,
(3) polyvinylpyrrolidone,
(4) high molecular weight polyethylene glycol,
(5) polyglycoside,
(6) polyvinylcaprolactam,
(7) vinylpyrrolidone/vinyl acetate copolymer,
(8) vinylpyrrolidone/vinyl caprolactam/ammonium derivative terpolymer, where the ammonium derivative monomer has 6 to 12 carbon atoms and is selected from diallylamino alkyl methacrylamides, dialkyl dialkenyl ammonium halides, and a dialkylamino alkyl methacrylate or acrylate,
(9) polyvinylalcohol, and
(10) cationic cellulose polymer;
(d) optionally, one or more detersive surfactants particularly selected from carboxylate, nonionic, cationic and amphoteric surfactants;
(e) optionally, one or more organic solvents; and
(f) water.

The compositions described above may include one or more further conventional optional constituents such as: pH buffering agents, perfumes, perfume carriers, colorants, hydrotropes, germicides, fungicides, anti-oxidants, anti-corrosion agents, and the like.

Preferred compositions according to the invention are largely aqueous, and are readily pourable and pumpable when packaged from a manually operable pump, such as a ‘trigger spray’ dispenser. The preferred compositions of the invention feature good cleaning, disinfection of hard surfaces and little or not buildup of residue on treated hard surfaces.

According to a first aspect of the invention there is provided a hard surface cleaning and disinfecting composition which comprises (preferably, consisting essentially of) the following constituents:
(a) at least one cationic surfactant having germicidal properties;
(b) a fluorosurfactant selected from the group of nonionic fluorosurfactants, cationic fluorosurfactants, perfluoroalkylethyl fluorosurfactants, and mixtures thereof;
(c) a film forming polymer selected from the group consisting of
   (1) a polymer having the formula

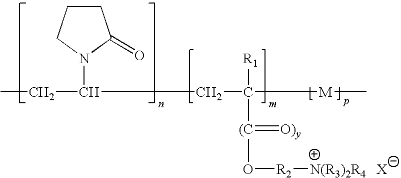

in which n represents from 20 to 99 and preferably from 40 to 90 mol %, m represents from 1 to 80 and preferably from 5 to 40 mol %; p represents 0 to 50 mol, (n+m+p=100); R₁ represents H or CH₃; y represents 0 or 1; R₂ represents —CH₂—CHOH—CH₂— or CₓH₂ₓ in which x is 2 to 18; R₃ represents CH₃, C₂H₅ or t-butyl; R₄ represents CH₃, C₂H₅ or benzyl; X represents Cl, Br, I, ½SO₄, HSO₄ and CH₃SO₃; and M is a vinyl or vinylidene monomer copolymerisable with vinyl pyrrolidone other than the monomer identified in [ ]ₘ,
(2) water soluble polyethylene oxide,
(3) polyvinylpyrrolidone,
(4) high molecular weight polyethylene glycol,
(5) polyglycoside,
(6) polyvinylcaprolactam,
(7) vinylpyrrolidone/vinyl acetate copolymer,
(8) vinylpyrrolidone/vinyl caprolactam/ammonium derivative terpolymer, where the ammonium derivative monomer has 6 to 12 carbon atoms and is selected from diallylamino alkyl methacrylamides, dialkyl dialkenyl ammonium halides, and a dialkylamino alkyl methacrylate or acrylate,
(9) polyvinylalcohol, and
(10) cationic cellulose polymer;
(d) one or more detersive surfactants particularly selected from carboxylate, nonionic, cationic and amphoteric surfactants;
(e) one or more organic solvents; and
(f) water.

The compositions described above may include one or more further conventional optional constituents such as: pH buffering agents, perfumes, perfume carriers, colorants, hydrotropes, germicides, fungicides, anti-oxidants, anti-corrosion agents, and the like.

Preferred compositions according to the invention are largely aqueous, and are readily pourable and pumpable when packaged from a manually operable pump, such as a ‘trigger spray’ dispenser. The preferred compositions of the invention feature good cleaning, disinfection of hard surfaces and little or not buildup of residue on treated hard surfaces.

According to a second aspect of the invention there is provided a hard surface cleaning and disinfecting composition which comprises (preferably, consisting essentially of) the following constituents:
(a) at least one cationic surfactant having germicidal properties;
(b) a fluorosurfactant selected from the group of nonionic fluorosurfactants, cationic fluorosurfactants, perfluoroalkylethyl fluorosurfactants, and mixtures thereof;
(c) a film forming polymer selected from the group consisting of
   (1) polymer having the formula

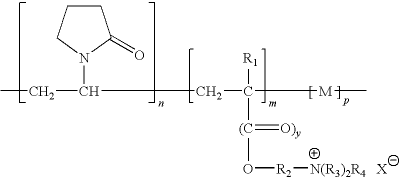

in which n represents from 20 to 99 and preferably from 40 to 90 mol %, m represents from 1 to 80 and preferably from 5 to 40 mol %; p represents 0 to 50 mol, (n+m+p=100); R₁ represents H or CH₃; y represents 0 or 1; R₂ represents —CH₂—CHOH—CH₂— or CₓH₂ₓ in which x is 2 to 18; R₃ represents CH₃, C₂H₅ or t-butyl; R₄ represents CH₃, C₂H₅ or benzyl; X— represents Cl, Br, I, ½SO₄, HSO₄ and CH₃SO₃; and M is a vinyl or vinylidene monomeric copolymerisable with vinyl pyrrolidone other than the monomer identified in [ ]ₘ;
(2) water soluble polyethylene oxide,
(3) polyvinylpyrrolidone,
(4) high molecular weight polyethylene glycol,
(5) polyglycoside,
(6) polyvinylcaprolactam,
(7) vinylpyrrolidone/vinyl acetate copolymer,
(8) vinylpyrrolidone/vinyl caprolactam/ammonium derivative terpolymer, where the ammonium derivative monomer has 6 to 12 carbon atoms and is selected from diallylamino alkyl methacrylamides, dialkyl dialkenyl ammonium halides, and a dialkylamino alkyl methacrylate or acrylate,
(9) polyvinylalcohol, and
(10) cationic cellulose polymer;
(d) one or more detersive surfactants particularly selected from carboxylate, nonionic, cationic and amphoteric surfactants; and
(f) water
   wherein the compositions are essentially free of (e) one or more organic solvents.

The compositions described above may include one or more further conventional optional constituents such as: pH buffering agents, perfumes, perfume carriers, colorants, hydrotropes, germicides, fungicides, anti-oxidants, anti-corrosion agents, and the like.

Preferred compositions according to the invention are largely aqueous, and are readily pourable and pumpable when packaged from a manually operable pump, such as a ‘trigger spray’ dispenser. The preferred compositions of the invention feature good cleaning, disinfection of hard surfaces and little or not buildup of residue on treated hard surfaces.

According to a third aspect of the invention there is provided a hard surface cleaning and disinfecting composition which comprises (preferably, consisting essentially of) the following constituents:
(a) at least one cationic surfactant having germicidal properties;
(b) a fluorosurfactant selected from the group of nonionic fluorosurfactants, cationic fluorosurfactants, perfluoroalkylethyl fluorosurfactants, and mixtures thereof;
(c) a film forming polymer selected from the group consisting of
   (1) polymer having the formula

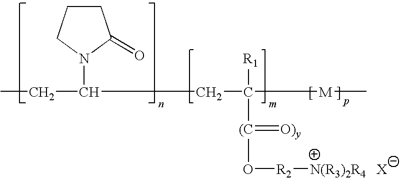

in which n represents from 20 to 99 and preferably from 40 to 90 mol %, m represents from 1 to 80 and preferably from 5 to 40 mol %; p represents 0 to 50 mol, (n+m+p=100); R₁ represents H or CH₃; y represents 0 or 1; R₂ represents —CH₂—CHOH—CH₂— or CₓH₂ₓ in which x is 2 to 18; R₃ represents CH₃, C₂H₅ or t-butyl; R₄ represents CH₃, C₂H₅ or benzyl; X— represents Cl, Br, I, ½SO₄, HSO₄ and CH₃SO₃; and M is a vinyl or vinylidene monomeric copolymerisable with vinyl pyrrolidone other than the monomer identified in [ ]ₘ;
(2) water soluble polyethylene oxide,
(3) polyvinylpyrrolidone,
(4) high molecular weight polyethylene glycol,
(5) polyglycoside,
(6) polyvinylcaprolactam,
(7) vinylpyrrolidone/vinyl acetate copolymer,
(8) vinylpyrrolidone/vinyl caprolactam/ammonium derivative terpolymer, where the ammonium derivative monomer has 6 to 12 carbon atoms and is selected from diallylamino alkyl methacrylamides, dialkyl dialkenyl ammonium halides, and a dialkylamino alkyl methacrylate or acrylate,
(9) polyvinylalcohol, and
(10) cationic cellulose polymer;
(e) one or more organic solvents; and
(f) water
   wherein the compositions are essentially free of (d) detersive surfactants (except for the germicidal constituent) particularly selected from carboxylate, nonionic, cationic and amphoteric surfactants.

The compositions described above may include one or more further conventional optional constituents such as: pH buffering agents, perfumes, perfume carriers, colorants, hydrotropes, germicides, fungicides, anti-oxidants, anti-corrosion agents, and the like.

Preferred compositions according to the invention are largely aqueous, and are readily pourable and pumpable when packaged from a manually operable pump, such as a ‘trigger spray’ dispenser. The preferred compositions of the invention feature good cleaning, disinfection of hard surfaces and little or not buildup of residue on treated hard surfaces.

According to a fourth aspect of the invention there is provided a hard surface cleaning and disinfecting composition which comprises (preferably, consisting essentially on the following constituents:
(a) at least one cationic surfactant having germicidal properties;
(b) a fluorosurfactant selected from the group of nonionic fluorosurfactants, cationic fluorosurfactants, perfluoroalkylethyl fluorosurfactants, and mixtures thereof;
(c) a film forming polymer selected from the group consisting of
   (1) polymer having the formula

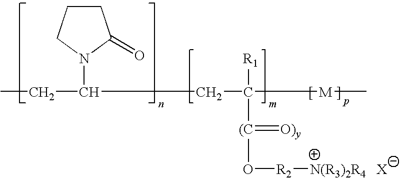

in which n represents from 20 to 99 and preferably from 40 to 90 mol %, m represents from 1 to 80 and preferably from 5 to 40 mol %; p represents 0 to 50 mol, (n+m+p=100); R₁ represents H or CH₃; y represents 0 or 1; R₂ represents —CH₂—CHOH—CH₂— or CₓH₂ₓ in which x is 2 to 18; R₃ represents CH₃, C₂H₅ or t-butyl; R₄ represents CH₃, C₂H₅ or benzyl; X— represents Cl, Br, I, ½SO₄, HSO₄ and CH₃SO₃; and M is a vinyl or vinylidene monomeric copolymerisable with vinyl pyrrolidone other than the monomer identified in [ ]ₘ;
(2) water soluble polyethylene oxide,
(3) polyvinylpyrrolidone,
(4) high molecular weight polyethylene glycol,
(5) polyglycoside,
(6) polyvinylcaprolactam,
(7) vinylpyrrolidone/vinyl acetate copolymer,
(8) vinylpyrrolidone/vinyl caprolactam/ammonium derivative terpolymer, where the ammonium derivative monomer has 6 to 12 carbon atoms and is selected from diallylamino alkyl methacrylamides, dialkyl dialkenyl ammonium halides, and a dialkylamino alkyl methacrylate or acrylate,
(9) polyvinylalcohol, and
(10) cationic cellulose polymer; and
(f) water
   wherein the compositions are essentially free of (d) detersive surfactants (except for the germicidal constituent) particularly selected from carboxylate, nonionic, cationic and amphoteric surfactants, as well as being essentially free of (e) one or more organic solvents.

The compositions described above may include one or more further conventional optional constituents such as: pH buffering agents, perfumes, perfume carriers, colorants, hydrotropes, germicides, fungicides, anti-oxidants, anti-corrosion agents, and the like.

Preferred compositions according to the invention are largely aqueous, and are readily pourable and pumpable when packaged from a manually operable pump, such as a ‘trigger spray’ dispenser. The preferred compositions of the invention feature good cleaning, disinfection of hard surfaces and little or not buildup of residue on treated hard surfaces.

Preferably for the above aspects of the invention, (b) fluorosurfactant is selected from the group

CₙF₂ₙ₊₁SO₂N(C₂H₅)(CH₂CH₂O)ₓCH₃

wherein: n has a value of from 1-12, preferably from 4-12, most preferably 8;
x has a value of from 4-18, preferably from 4-10, most preferably 7;

RfCH₂CH₂O(CH₂CH₂O)ₓH

wherein
Rf is F(CF₂CF₂)_{y} and
either x is 0 to about 15 and y is 1 to about 7, or
x is 0 to about 25 and y is 1 to about 9;

CₙF₂ₙ₊₁SO₂NHC₃H₆N⁺(CH₃)₃I⁻

wherein n-8;

CF₃—(CF₂)ₙ—(CH₂)ₘSCH₂CHOH—CH₂—N+R₁R₂R₃Cl⁻

wherein: n is 5-9 and m is 2, and R₁, R₂ and R₃ are —CH₃;

CF₃—(CF₂)₅—CH₂—CH₂—S—CH₂—CH(OH)—CH₂—N(CH₃)₃⁺Cl⁻;

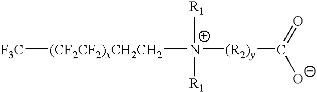

wherein:
each of R₁ and R₂ independently is C₁-C₆ alkyl or C₁-C₆ alkenyl group, preferably a C₁-C₃ alkyl group, particularly a methyl group;
x is an integer from 1-20; preferably is an integer from 8-12;
y is an integer from 1-20; preferably is an integer from 1-10;

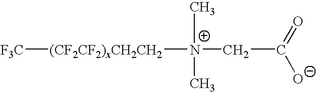

wherein: x has a value of 8-12;

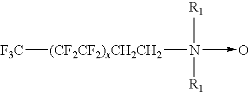

wherein:
R₁ is a C₁-C₆ alkyl or C₁-C₆ alkenyl group; and,
x is an integer from 1-20; preferably is an integer from 8-12;

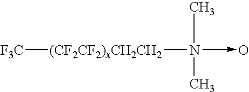

wherein: x has a value of 8-12; or

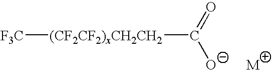

wherein: M is an alkali or alkaline earth metal counterion.

The inventive compositions necessarily include (a) at least one cationic surfactant having germicidal properties.

Particularly preferred for use as the (a) is at least one cationic surfactant which is found to provide a broad antibacterial or sanitizing function. Any cationic surfactant which satisfies these requirements may be used and are considered to be within the scope of the present invention, and mixtures of two or more cationic surface active agents, viz., cationic surfactants may also be used. Cationic surfactants are well known, and useful cationic surfactants may be one or more of those described for example in McCutcheon's Detergents and Emulsifiers, North American Edition, 2001; Kirk-Othmer, Encyclopedia of Chemical Technology, 4th Ed., Vol. 23, pp. 478-541, the contents of which are herein incorporated by reference.

Examples of preferred cationic surfactant compositions useful in the practice of the instant invention are those which provide a germicidal effect to the concentrate compositions, and especially preferred are quaternary ammonium compounds and salts thereof, which may be characterized by the general structural formula:

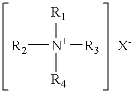

where at least one of R₁, R₂, R₃ and R₄ is a alkyl, aryl or alkylaryl substituent of from 6 to 26 carbon atoms, and the entire cation portion of the molecule has a molecular weight of at least 165. The alkyl substituents may be long-chain alkyl, long-chain alkoxyaryl, long-chain alkylaryl, halogen-substituted long-chain alkylaryl, long-chain alkylphenoxyalkyl, arylalkyl, etc. The remaining substituents on the nitrogen atoms other than the abovementioned alkyl substituents are hydrocarbons usually containing no more than 12 carbon atoms. The substituents R₁, R₂, R₃ and R₄ may be straight-chained or may be branched, but are preferably straight-chained, and may include one or more amide, ether or ester linkages. The counterion X may be any salt-forming anion which permits water solubility of the quaternary ammonium complex.

Exemplary quaternary ammonium salts within the above description include the alkyl ammonium halides such as cetyl trimethyl ammonium bromide, alkyl aryl ammonium halides such as octadecyl dimethyl benzyl ammonium bromide, N-alkyl pyridinium halides such as N-cetyl pyridinium bromide, and the like. Other suitable types of quaternary ammonium salts include those in which the molecule contains either amide, ether or ester linkages such as octyl phenoxy ethoxy ethyl dimethyl benzyl ammonium chloride, N-(laurylcocoaminoformylmethyl)-pyridinium chloride, and the like. Other very effective types of quaternary ammonium compounds which are useful as germicides include those in which the hydrophobic radical is characterized by a substituted aromatic nucleus as in the case of lauryloxyphenyltrimethyl ammonium chloride, cetylaminophenyltrimethyl ammonium methosulfate, dodecylphenyltrimethyl ammonium methosulfate, dodecylbenzyltrimethyl ammonium chloride, chlorinated dodecylbenzyltrimethyl ammonium chloride, and the like.

Preferred quaternary ammonium compounds which act as germicides and which are found to be useful in the practice of the present invention include those which have the structural formula:

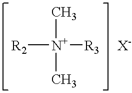

wherein R₂ and R₃ are the same or different C₈-C₁₂alkyl, or R₂ is C₁₂₋₁₆alkyl, C₈₋₁₈alkylethoxy, C₈₋₁₈alkylphenoxyethoxy and R₃ is benzyl, and X is a halide, for example chloride, bromide or iodide, or is a methosulfate anion. The alkyl groups recited in R₂ and R₃ may be straight-chained or branched, but are preferably substantially linear.

Particularly useful quaternary germicides include compositions which include a single quaternary compound, as well as mixtures of two or more different quaternary compounds.

Such useful quaternary compounds are available under the BARDAC®, BARQUAT®, HYAMINE®, LONZABAC®, BTC®, and ONYXIDE® trademarks, which are more fully described in, for example, McCutcheon's Functional Materials (Vol. 2), North American Edition, 2001, and the respective product literature from the suppliers identified below. For example, BARDAC® 205M is described to be a liquid containing alkyl dimethyl benzyl ammonium chloride, octyl decyl dimethyl ammonium chloride; didecyl dimethyl ammonium chloride, and dioctyl dimethyl ammonium chloride (50% active) (also available as 80% active (BARDAC® 208M)); described generally in McCutcheon's as a combination of alkyl dimethyl benzyl ammonium chloride and dialkyl dimethyl ammonium chloride); BARDAC® 2050 is described to be a combination of octyl decyl dimethyl ammonium chloride/didecyl dimethyl ammonium chloride, and dioctyl dimethyl ammonium chloride (50% active) (also available as 80% active (BARDAC® 2080)); BARDAC® 2250 is described to be didecyl dimethyl ammonium chloride (50% active); BARDAC® LF (or BARDAC® LF-80), described as being based on dioctyl dimethyl ammonium chloride (BARQUAT® MB-50, MX-50, OJ-50 (each 50% liquid) and MB-80 or MX-80 (each 80% liquid) are each described as an alkyl dimethyl benzyl ammonium chloride; BARDAC® 4250 and BARQUAT® 4250Z (each 50% active) or BARQUAT® 4280 and BARQUAT® 4280Z (each 80% active) are each described as alkyl dimethyl benzyl ammonium chloride/alkyl dimethyl ethyl benzyl ammonium chloride. Also, HYAMINE® 1622, described as diisobutyl phenoxy ethoxy ethyl dimethyl benzyl ammonium chloride (available either as 100% actives or as a 50% actives solution); HYAMINE® 3500 (50% actives), described as alkyl dimethyl benzyl ammonium chloride (also available as 80% active (HYAMINE® 3500-80); and HYAMINE® 2389 described as being based on methyldodecylbenzyl ammonium chloride and/or methyldodecylxylene-bis-rimethyl ammonium chloride. (BARDAC®, BARQUAT® and HYAMINE® are presently commercially available from Lonza, Inc., Fairlawn, N.J.). BTC® 50 NF (or BTC® 65 NF) is described to be alkyl dimethyl benzyl ammonium chloride (50% active); BTC® 99 is described as didecyl dimethyl ammonium chloride (50% active); BTC® 776 is described to be myristalkonium chloride (50% active); BTC® 818 is described as being octyl decyl dimethyl ammonium chloride, didecyl dimethyl ammonium chloride, and dioctyl dimethyl ammonium chloride (50% active) (available also as 80% active (BTC® 818-80%)); BTC® 824 and BTC® 835 are each described as being of alkyl dimethyl benzyl ammonium chloride (each 50% active); BTC® 885 is described as a combination of BTC® 835 and BTC® 818 (50% active) (available also as 80% active (BTC® 888)); BTC® 1010 is described as didecyl dimethyl ammonium chloride (50% active) (also available as 80% active (BTC® 1010-80)); BTC® 2125 (or BTC® 2125 M) is described as alkyl dimethyl benzyl ammonium chloride and alkyl dimethyl ethylbenzyl ammonium chloride (each 50% active) (also available as 80% active (BTC® 2125-80 or BTC® 2125 M)); BTC® 2565 is described as alkyl dimethyl benzyl ammonium chlorides (50% active) (also available as 80% active (BTC® 2568)); BTC® 8248 (or BTC® 8358) is described as alkyl dimethyl benzyl ammonium chloride (80% active) (also available as 90% active (BTC® 8249)); ONYXIDE® 3300 is described as n-alkyl dimethyl benzyl ammonium saccharinate (95% active). (BTC® and ONYXIDE® are presently commercially available from Stepan Company, Northfield, Ill.). Polymeric quaternary ammonium salts based on these monomeric structures are also considered desirable for the present invention. One example is POLYQUAT®, described as being a 2-butenyidimethyl ammonium chloride polymer.

The cationic surfactant having germicidal properties may be present in any effective amount, but generally need not be present in amounts in excess of about 10% wt. based on the total weight of the composition. The preferred germicidal cationic surfactant(s) may be present in the concentrated liquid disinfectant compositions in amounts of from about 0.001% by weight to up to about 10% by weight, very preferably about 0.01-8% by weight, more preferably in amount of between 0.5-6% by weight, and most preferably from 2-4% by weight. It is particularly advantageous that the preferred germicidal cationic surfactant(s) are present in amounts of at least 200 parts per million (ppm), preferably in amounts of 200-700 ppm, more preferably in amounts of from 250-500 ppm, and very especially in amount of from 300-500 ppm.

The inventive compositions necessarily include (b) a fluorosurfactant selected from the group of nonionic fluorosurfactants, cationic fluorosurfactants, perfluoroalkylethyl fluorosurfactants, and mixtures thereof which are soluble in the aqueous compositions being taught herein, particularly compositions which do not include further detersive surfactants, or further organic solvents, or both. Particularly useful nonionic fluorosurfactant compounds are found among the materials presently commercially marketed under the tradename Fluorad® (ex. 3M Corp.).

An especially useful nonionic fluorosurfactant compounds include those which is believed to conform to the following formulation:

CₙF₂ₙ₊₁SO₂N(C₂H₅)(CH₂CH₂O)ₓCH₃

wherein: n has a value of from 1-12, preferably from 4-12, most preferably 8;
x has a value of from 4-18, preferably from 4-10, most preferably 7;
   which is described to be a nonionic fluorinated alkyl alkoxylate and which is sold as Fluorad® FC-171 (ex. 3M Corp.).

Exemplary useful fluorosurfactants include those sold as Fluorad® FC-740, generally described to be fluorinated alkyl esters; Fluorad® FC430, generally described to be fluorinated alkyl esters; Fluorad® FC-431, generally described to be fluorinated alkyl esters; and, Fluorad® FC-I 70-C, which is generally described as being fluorinated alkyl polyoxyethylene ethanols.

Additionally particularly useful nonionic fluorosurfactant compounds are also found among the materials marketed under the tradename ZONYL® (DuPont Performance Chemicals). These include, for example, ZONYL® FSO and ZONYL® FSN. These compounds have the following formula:

RfCH₂CH₂O(CH₂CH₂O)ₓH

where Rf is F(CF₂CF₂)_{y}. For ZONYL® FSO, x is 0 to about 15 and y is 1 to about 7. For ZONYL® FSN, x is 0 to about 25 and y is 1 to about 9.

An example of a useful cationic fluorosurfactant compound has the following structure:

CₙF₂ₙ₊₁SO₂NHC₃H₆N⁺(CH₃)₃I⁻

where n-8. This cationic fluorosurfactant is available under the tradename Fluorad® FC-135 from 3M.

Another example of a useful cationic fluorosurfactant is

CF₃—(CF₂)ₙ—(CH₂)ₘSCH₂CHOH—CH₂—N⁺R₁R₂R₃Cl⁻

wherein: n is 5-9 and m is 2, and R₁, R₂ and R₃ are —CH₃. This cationic fluorosurfactant is available under the tradename ZONYL® FSD (available from DuPont, described as 2-hydroxy-3-((gamma-omega-perfluoro-C₆₋₂₀-alkyl)thio)-N,N,N-trimethyl-1-propyl ammonium chloride).

Yet another example of a cationic fluorosurfactant has the formula

CF₃—(CF₂)₅—CH₂—CH₂—S—CH₂—CH(OH)—CH₂—N(CH₃)₃⁺C⁻

known as Lodyne S-106A and available from Ciba Specialty Chemicals.

Other cationic fluorosurfactants suitable for use in the present invention are also

described in EP 866 115, as well as in the corresponding US application the contents of which are hereby incorporated herein by reference.

An exemplary perfluoroalkylethyl fluorosurfactant compound is a perfluoroalkylethyl betaine fluorosurfactant which may be represented by the following general structure:

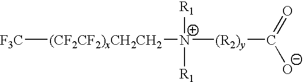

wherein:
each of R₁ and R₂ independently is C₁-C₆ alkyl or C₁-C₆ alkenyl group, preferably a C₁-C₃ alkyl group, particularly a methyl group;
x is an integer from 1-20; preferably is an integer from 8-12;
y is an integer from 1-20; preferably is an integer from 1-10.
   Preferably both of the R₁ groups are the same, and are both R₁ and R₂ are each a methyl group, and y has an integer value of at least 1. Such perfluoroalkylethyl betaine fluorosurfactants are commercially available as REPEARL fluorosurfactants (ex. Mitsubishi Int'l. Corp.). Another exemplary perfluoroalkylethyl betaine fluorosurfactant is REPEARL FS-131, which may be represented as:

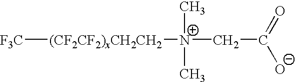

wherein: x has a value of 8-12.

Another exemplary perfluoroalkylethyl fluorosurfactant compound is a perfluoroalkylethyl amine oxide fluorosurfactant is one which may be represented by the following structure:

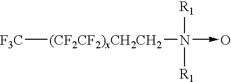

wherein:
R₁ is a C₁-C₆ alkyl or C₁-C₆ alkenyl group, preferably each are a C₁-C₃ alkyl group, and particularly a methyl group; and,
x is an integer from 1-20; preferably is an integer from 8-12.

Preferably both of the R₁ groups are the same, and are both methyl groups, and x is 4 to 16. Such perfluoroalkylethyl amine oxide fluorosurfactants are commercially available as REPEARL fluorosurfactants (ex. Mitsubishi Int'l. Corp.). An exemplary and particularly preferred perfluoroalkylethyl amine oxide fluorosurfactant is REPEARL FS-141, which may be represented as:

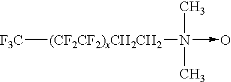

wherein: x has a value of 8-12.

Still further exemplary perfluoroalkylethyl fluorosurfactant compounds include perfluoroalkylethyl carboxylate fluorosurfactant, or salt thereof, which may be represented by the following structure:

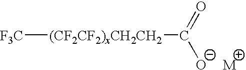

wherein: M is a counterion which renders the compound soluble or miscible in water or in an aqueous/alcoholic solution, such as a water/methanol solution. By way of non-limiting example, such a counterion may be an alkali or alkaline earth metal counterion, such as Li, Na, K, Ca, or Mg. Particularly useful and preferred are sodium and potassium counterions. Such perfluoroalkylethyl carboxylate fluorosurfactants are commercially available as REPEARL fluorosurfactants (ex. Mitsubishi Int'l. Corp.). An exemplary and particularly preferred perfluoroalkylethyl betaine fluorosurfactant is REPEARL FS-111.

The fluorosurfactant selected from the group of nonionic fluorosurfactants, cationic fluorosurfactants, perfluoroalkylethyl fluorosurfactants and mixtures thereof is present in amounts of 0.001 to 20% wt., preferably from 0.01 to 15% wt., and more preferably from 0.01 to 10% wt, more preferably from 0.01 to 5% wt. and even more preferably from 0.01 to 2.5% wt.

The compositions of the present invention also include (c) a film forming polymer selected from the group consisting of
(1) polymer having the formula

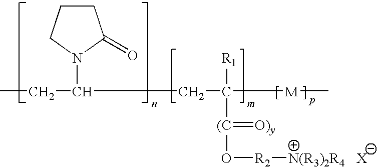

in which n represents from 20 to 99 and preferably from 40 to 90 mol %, m represents from 1 to 80 and preferably from 5 to 40 mol %; p represents 0 to 50 mol, (n+m+p=100); R₁ represents H or CH₃; y represents 0 or 1; R₂ represents
—CH₂—CHOH—CH₂— or CₓH₂ₓ in which x is 2 to 18; R₃ represents CH₃, C₂H₅ or t-butyl; R₄ represents CH₃, C₂H₅ or benzyl; X represents Cl, Br, I, ½SO₄, HSO₄ and CH₃SO₃; and M is a vinyl or vinylidene monomeric copolymerisable with vinyl pyrrolidone other than the monomer identified in [ ]ₘ;
(2) water soluble polyethylene oxide,
(3) polyvinylpyrrolidone,
(4) high molecular weight polyethylene glycol,
(5) polyglycoside,
(6) polyvinylcaprolactam,
(7) vinylpyrrolidone/vinyl acetate copolymer,
(8) vinylpyrrolidone/vinyl caprolactam/ammonium derivative terpolymer, where the ammonium derivative monomer has 6 to 12 carbon atoms and is selected from diallylamino alkyl methacrylamides, dialkyl dialkenyl ammonium halides, and a dialkylamino alkyl methacrylate or acrylate, and
(9) polyvinylalcohol, and
(10) cationic cellulose polymer.

The film forming polymers are further described below. The film forming polymers, when present in the compositions, form a film on the surfaces when the inventive compositions are applied. This film provides a barrier against subsequent soiling or staining of the surfaces, however, they may be readily removed in a subsequent cleaning of the hard surface with conventional hard surface cleaning compositions which include one or more detersive surfactants. It is also hypothesized that the barrier of the polymer film reduces the migration or mobility of bacteria and other undesired microbes which may have been present on the hard surface.

A first film-forming polymer is one having the formula

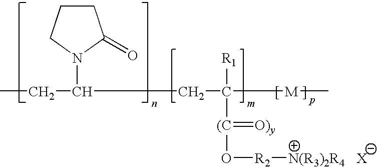

are more fully described in U.S. Pat. No. 4,445,521, U.S. Pat. No. 4,165,367, U.S. Pat. No. 4,223,009, U.S. Pat. No. 3,954,960, as well as GB 1,331,819, the contents of which are hereby incorporated by reference.

The monomer unit within [ ]ₘ is, for example, a di-lower alkylamine alkyl acrylate or methacrylate or a vinyl ether derivative. Examples of these monomers include dimethylaminomethyl acrylate, dimethylaminomethyl methacrylate, diethylaminomethyl acrylate, diethylaminomethyl methacrylate, dimethylaminoethyl acrylate, dimethylaminoethyl methacrylate, dimethylaminobutyl acrylate, dimethylaminobutyl methacrylate, dimethylaminoamyl methacrylate, diethylaminoamyl methacrylate, dimethylaminohexyl acrylate, diethylaminohexyl methacrylate, dimethylaminooctyl acrylate, dimethylaminooctyl methacrylate, diethylaminooctyl acrylate, diethylaminooctyl methacrylate, dimethylaminodecyl methacrylate, dimethylaminododecyl methacrylate, diethylaminolauryl acrylate, diethylaminolauryl methacrylate, dimethylaminostearyl acrylate, dimethylaminostearyl methacrylate, diethylaminostearyl acrylate, diethylaminostearyl methacrylate, di-t-butylaminoethyl methacrylate, di-t-butylaminoethyl acrylate, and dimethylamino vinyl ether.

Monomer M, which can be optional (p is up to 50) can comprise any conventional vinyl monomer copolymerizable with N-vinyl pyrrolidone. Thus, for example, suitable conventional vinyl monomers include the alkyl vinyl ethers, e.g., methyl vinyl ether, ethyl vinyl ether, octyl vinyl ether, etc.; acrylic and methacrylic acid and esters thereof, e.g., methacrylate, methyl methacrylate, etc.; vinyl aromatic monomers, e.g., styrene, a-methyl styrene, etc; vinyl acetate; vinyl alcohol; vinylidene chloride; acrylonitrile and substituted derivatives thereof; methacrylonitrile and substituted derivatives thereof; acrylamide and methacrylamide and N-substituted derivatives thereof; vinyl chloride, crotonic acid and esters thereof; etc. Again, it is noted that such optional copolymerizable vinyl monomer can comprise any conventional vinyl monomer copolymerizable with N-vinyl pyrrolidone.

The film-forming polymers of the present invention are generally provided as a technical grade mixture which includes the polymer dispersed in an aqueous or aqueous/alcoholic carrier. Such include materials which are presently commercially available include quaternized copolymers of vinylpyrrolidone and dimethylaminoethyl methacrylate sold as Gafquat® copolymers (ex. ISP Corp., Wayne, N.J.) which are available in a variety of molecular weights.

Further exemplary useful examples of the film-forming polymers of the present invention include quaternized copolymers of vinylpyrrolidone and dimethylaminoethyl methacrylate as described in U.S. Pat. No. 4,080,310, to Ng, the contents of which are herein incorporated by reference. Such quaternized copolymers include those according to the general formula:

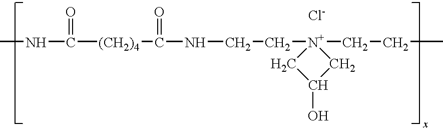

wherein “x” is about 40 to 60. Further exemplary useful copolymers include copolymers of vinylpyrrolidone and dimethylaminoethylmethacrylate quaternized with diethyl sulphate (available as Gafquat® 755 ex., ISP Corp., Wayne, N.J.).

A particularly useful film-forming polymer according to the invention is a quaternized polyvinylpyrrolidone/dimethylamino ethylmethacrylate copolymer which is commercially available as Gafquat® 734, is disclosed by its manufacturer to be:

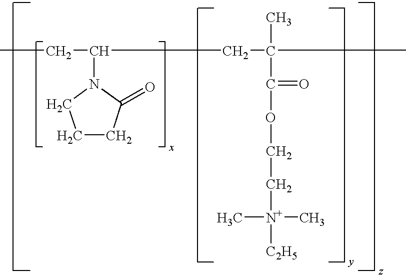

wherein x, y and z are at least 1 and have values selected such that the total molecular weight of the quaternized polyvinylpyrrolidone/dimethylamino ethylmethacrylate copolymer is at least 10,000 more desirably has an average molecular weight of 50,000 and most desirably exhibits an average molecular weight of 100,000. A further useful, but less preferred quaternized polyvinylpyrrolidone/dimethylamino ethylmethacrylate copolymer is available as Gafquat® 755N which is similar to the Gafquat® 734 material describe above but has an average molecular weight of about 1,000,000. These materials are sometimes referred to as “Polyquaternium-11”.

Polyethylene oxides for use in the compositions according to the invention may be represented by the following structure:

(CH₂CH₂O)ₓ

where:

x has a value of from about 2000 to about 180,000.

Desirably, these polyethylene oxides may be further characterized as water soluble resins, having a molecular weight in the range of from about 100,000 to about 8,000,000. At room temperature (68° F., 20° C.) they are solids. Particularly useful as the film-forming, water soluble polyethylene oxide in the inventive compositions are POLYOX water-soluble resins (ex. Union Carbide Corp., Danbury Conn.).

Further contemplated as useful in the place of, or in combination with these polyethylene oxides are polypropylene oxides, or mixed polyethylene oxides-polypropylene oxides having molecular weights in excess of about 50,000 and if present, desirably having molecular weights in the range of from about 100,000 to about 8,000,000. According to particularly desirable embodiments of the invention, the film-forming constituent of the present invention is solely a water soluble polyethylene oxide.

The polyvinylpyrrolidone polymers useful in the present inventive compositions exhibit a molecular weight of at least about 5,000, with a preferred molecular weight of from about 6,000-3,000,000.

The polyvinylpyrrolidone is generally provided as a technical grade mixture of polyvinylpyrrolidone polymers within approximate molecular weight ranges. Exemplary useful polyvinylpyrrolidone polymers are available in the PVP line materials (ex. ISP Corp.) which include PVP K 15 polyvinylpyrrolidone described as having molecular weight in the range of from 6,000-15,000; PVP-K 30 polyvinylpyrrolidone with a molecular weight in the range of 40,000-80,000; PVP-K 60 polyvinylpyrrolidone with a molecular weight in the range of 240,000-450,000; PVP-K 90 polyvinylpyrrolidone with a molecular weight in the range of 900,000-1,500,000; PVP-K 120 polyvinylpyrrolidone with a molecular weight in the range of 2,000,000-3,000,000. Further preferred examples of polyvinylpyrrolidones are described in the Examples.

Other suppliers of polyvinylpyrrolidone include AllChem Industries Inc, Gainesville, Fla., Kraft Chemical Co., Melrose Park, Ill., Alfa Aesar, a Johnson Matthey Co., Ward Hill, Mass., and Monomer-Polymer & Dajac Labs Inc., Feasterville, Pa.

High molecular weight polyethylene glycol polymers useful in the present inventive compositions exhibit a molecular weight of at least about 100, preferably exhibits a molecular weight in the range of from about 100 to about 10,000 but most preferably a molecular weight in the range of from about 2000 to about 10,000.

Particularly useful high molecular weight polyethylene glycols are available under the tradename CARBOWAX® (ex. Union Carbide Corp.). Other suppliers of high molecular weight polyethylene glycols include Ashland Chemical Co., BASF Corp., Norman, Fox & Co., and Shearwater Polymers, Inc.

Exemplary polyglycosides include alkyl monoglycosides and polyglycosides which are prepared generally by reacting a monosaccharide, or a compound hydrolyzable to a monosaccharide with an alcohol such as a fatty alcohol in an acid medium.

Exemplary glycosides which may be used include alkylpolyglycoside surfactants which may be represented by formula I below:

RO(R′O)ₓ(Z)_{y}

wherein:

R is a monovalent organic radical containing from about 6 to about 30 carbon atoms;

R′ is a divalent hydrocarbon radical containing from about 2 to about

4 carbon atoms, especially ethyl and propyl radicals;

Z is a saccharide residue having from 4 to 8, especially about 5-6 carbon atoms;

O is an oxygen atom;

x is a number which has an average value from about 0 to about 12; and,

y is a number having an average value from about 1 to about 6.

By way of non-limiting examples useful alkylpolyglycosides include GLUCOPON® 225, described to be an alkylpolyglycoside in which the alkyl group contains 8 to 10 carbon atoms; APG® 325 and APG® 300, each described to be an alkyl polyglycoside in which the alkyl group contains 9 to 11 carbon atoms but having differing average degrees of polymerization; GLUCOPON® 625 and GLUCOPON® 600, each described to be an alkyl polyglycoside in which the alkyl groups contains 12 to 16 carbon atoms but having a different average degrees of polymerization; PLANTAREN® 2000, described to be a C₈₋₁₆alkylpolyglycoside; PLANTAREN® C₁₂₋₁₆ alkylpolyglycoside; PLANTAREN® 1200, described to be a C₁₂₋₁₆ alkylpolyglycoside. Each of these materials are presently commercially available from Cognis. Other examples include alkyl polyglycoside surfactant compositions which are comprised of mixtures of compounds of the aforesaid formula wherein Z represents a moiety derived from a reducing saccharide containing 5 or 6 carbon atoms; a is zero; b is a number from 1.8 to 3; and R is an alkyl radical having from 8 to 20 carbon atoms.

The most preferable alkylpolyglycoside compound is according to the structure:

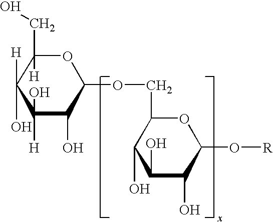

wherein:

R is an alkyl group, preferably a linear alkyl chain, which comprises C₈ to C₁₆ alkyl groups;

x is an integer value of from 0-3, inclusive.

Examples of such alkylpolyglycoside compounds according to the aforesaid structure include: where R is comprised substantially of C₈ and C₁₀ alkyl chains yielding an average value of about 9.1 alkyl groups per molecule (GLUCOPON 220 UP, GLUCOPON 225 DK); where R is comprised of C₈, C₁₀, C₁₂, C₁₄ and C₁₆ alkyl chains yielding an average value of about 10.3 alkyl groups per molecule (GLUCOPON 425N); where R is comprised substantially of C₁₂, C₁₄ and C₁₆ alkyl chains yielding an average value of about 12.8 alkyl groups per molecule (GLUCOPON 600 UP, GLUCOPON 625 CSUP, and GLUCOPON 625 FE, all of which are available from Cognis). Also useful as the alkylpolyglycoside compound is TRITON CG-110 (Union Carbide Corp. subsidiary of Dow Chemical). Further examples of commercially available alkylglycosides as described above include, for example, GLUCOPON 325N which is described as being a 50% C₉-C₁₁ alkyl polyglycoside, also commonly referred to as D-glucopyranoside (from Cognis). Particularly preferred as the alkylpolyglycoside compounds are those illustrated in the Examples.

Exemplary film-forming polyvinylcaprolactams include polyvinylcaprolactam compounds marketed under the tradename LUVISKOL® (ex. BASF Corp.). Such polyvinylcaprolactams may be represented by the following structural formula:

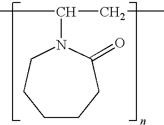

Where n has a value of at least about 800, and preferably a value in the range of from about 500 to about 1000.

Exemplary vinylpyrrolidone/vinylacetate copolymers which find use in the present inventive compositions include those vinylpyrrolidone, vinylacetate copolymers, examples of which are presently commercially available. Such vinylpyrrolidone/vinylacetate copolymers are comprised of vinylpyrrolidone monomers which may be represented by the following structural formula:

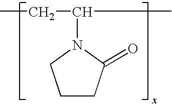

and vinylacetate monomers which may be represented by the following structural formula:

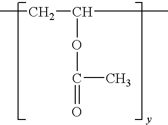

which are usually formed by a free-radical polymerization reaction to produce linear random vinylpyrrolidone/vinylacetate copolymers. The resultant vinylpyrrolidone/vinylacetate copolymers may comprise varying amounts of the individual vinylpyrrolidone monomers and vinylacetate monomers, with ratios of vinylpyrrolidone monomer to vinylacetate monomers from 30/70 to 70/30. The values of x and y in the structural formula should have values such that x+y=100 to 500, preferably x+y=150 to 300. Such values correspond to provide vinylpyrrolidone/vinylacetate copolymers having a total molecular weight in the range from about 10,000 to about 100,000, preferably from about 12,000 to about 60,000. Desirably the ratio of x:y is 0.1:4.0, preferably from 0.2:3.0. Such ratios of x:y provide the preferred vinylpyrrolidone/vinylacetate copolymers which have vinylpyrrolidone monomer to vinylacetate monomers from 0.3/2.5.

Such vinylpyrrolidone/vinylcaprolactam/ammonium derivative terpolymers are comprised of vinylpyrrolidone monomers which may be represented by the following structural formula:

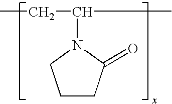

and vinylcaprolactam monomers which may be represented by the following structural formula:

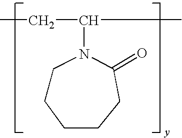

and dimethylaminoethylmethacrylate monomers which may be represented by the following structural formula:

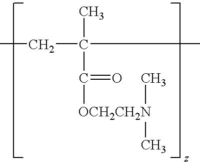

Exemplary vinylpyrrolidone/vinylcaprolactam/ammonium derivative terpolymer wherein the ammonium derivative monomer has 6 to 12 carbon atoms and is selected from diallylamino alkyl methacrylamides, dialkyl dialkenyl ammonium halides, and a dialkylamino alkyl methacrylate or acrylate which find use in the present inventive compositions include those marketed under the tradename ADVANTAGE® (ex. ISP.) as well as GAFFIX® (ex. ISP Corp). Such terpolymers are usually formed by a free-radical polymerization reaction to produce linear random vinylpyrrolidone/vinylcaprolactam/ammonium derivative terpolymers. The vinylpyrrolidone/vinylcaprolactam/ammonium derivative terpolymers useful in the present invention preferably comprise 17-32 weight % vinylpyrrolidone; 65-80 weight % vinylcaprolactam; 3-6 weight % ammonium derivative and 0-5 weight % stearyl methacrylate monomers. The polymers can be in the form of random, block or alternating structure having number average molecular weights ranging between about 20,000 and about 700,000; preferably between about 25,000 and about 500,000. The ammonium derivative monomer preferably has from 6 to 12 carbon atoms and is selected from the group consisting of dialkylaminoalkyl methacrylamide, dialkyl dialkenyl ammonium halide and a dialkylamino alkyl methacrylate or acrylate. Examples of the ammonium derivative monomer include, for example, dimethylamino propyl methacrylamide, dimethyl diallyl ammonium chloride, and dimethylamino ethyl methacrylate (DMAEMA). These terpolymers are more fully described in U.S. Pat. No. 4,521,404 to GAF Corporation, the contents of which are hereby incorporated by reference.

Exemplary film-forming polyvinylalcohols which find use in the present inventive compositions include those marketed under the tradename Airvol® (Air Products Inc., Allentown Pa.). These include: Airvol® 125, classified as a “super hydrolyzed” polyvinylalcohol polymer having a degree of hydrolysis of at least 99.3%, and a viscosity at a 4% solution in 20° C. water of from 28-32 cps; Airvol® 165, and Airvol® 165S, each being classified as “super hydrolyzed” polyvinylalcohol polymer having a degree of hydrolysis of at least 99.3%, and a viscosity at a 4% solution in 20° C. water of from 62-72 cps; Airvol® 103, classified as a “fully hydrolyzed” polyvinylalcohol polymer having a degree of hydrolysis of from 98.0-98.8%, and a viscosity at a 4% solution in 20° C. water of from 3.5-4.5 cps; Airvol® 305, classified as a “fully hydrolyzed” polyvinylalcohol polymer having a degree of hydrolysis of from 98.0-98.8%, and a viscosity at a 4% solution in 20° C. water of from 4.5-5.5 cps; Airvol® 107, classified as a “fully hydrolyzed” polyvinylalcohol polymer having a degree of hydrolysis of from 98.0-98.8%, and a viscosity at a 4% solution in 20° C. water of from 5.5-6.6 cps; Airvol® 321, classified as a “fully hydrolyzed” polyvinylalcohol polymer having a degree of hydrolysis of from 98.0-98.8%, and a viscosity at a 4% solution in 20° C. water of from 16.5-20.5 cps; Airvol® 325, classified as a “fully hydrolyzed” polyvinylalcohol polymer having a degree of hydrolysis of from 98.0-98.8%, and a viscosity at a 4% solution in 20° C. water of from 28-32 cps; and Airvol®350, classified as a “fully hydrolyzed” polyvinylalcohol polymer having a degree of hydrolysis of from 98.0-98.8%, and a viscosity at a 4% solution in 20° C. water of from 62-72 cps; Airvol® 425, classified as being an “intermediate hydrolyzed” polyvinylalcohol polymer classified having a degree of hydrolysis of from 95.5-96.5%, and a viscosity at a 4% solution in 20° C. water of from 27-31 cps; Airvol® 502, classified as a “partially hydrolyzed” polyvinylalcohol polymer having a degree of hydrolysis of from 87.0-89.0%, and a viscosity at a 4% solution in 20° C. water of from 3.0-3.7 cps; Airvole 203 and Airvol® 203S, each classified as a “partially hydrolyzed” polyvinylalcohol polymer having a degree of hydrolysis of from 87.0-89.0%, and a viscosity at a 4% solution in 20° C. water of from 3.5-4.5 cps; Airvol® 205 and Airvol® 205S, each classified as a “partially hydrolyzed” polyvinylalcohol polymer having a degree of hydrolysis of from 87.0-89.0%, and a viscosity at a 4% solution in 20° C. water of from 5.2-6.2 cps; Airvol® 523, classified as a “partially hydrolyzed” polyvinylalcohol polymer having a degree of hydrolysis of from 87.0-89.0%, and a viscosity at a 4% solution in 20° C. water of from 23-27 cps; and Airvol® 540, each classified as a “partially hydrolyzed” polyvinylalcohol polymer having a degree of hydrolysis of from 87.0-89.0%, and a viscosity at a 4% solution in 20° C. water of from 45-55 cps.

Particularly preferred are polyvinyl alcohol polymers which exhibit a degree of hydrolysis in the range of from 87%-89% and which desirably also exhibit a viscosity at a 4% solution in 20° C. water of from 3.0-100.0 cps.

Exemplary cationic cellulose polymers which find use in the present inventive compositions have been described in U.S. Pat. No. 5,830,438 as being a copolymer of cellulose or of a cellulose derivative grafted with a water-soluble monomer in the form of quaternary ammonium salt, for example, halide (e.g., chloride, bromide, iodide), sulfate and sulfonate. Such polymers are described in U.S. Pat. No. 4,131,576 to National Starch & Chemical Company, the contents of which are hereby hydroxyethyl- and hydroxypropylcelluloses grafted with a salt of methacryloylethyltrimethyl ammonium, methacrylamidopropyltrimethyl ammonium, or dialkyldiallyl ammonium, wherein each alkyl has at least one carbon atom and wherein the number of carbon atoms is such that the material is water soluble, preferably from 1 to about 20 carbon atoms, more preferably from 1 to about 10 carbon atoms, such as methyl, ethyl, propyl, butyl and the like. The preferred materials can be purchased for example under the trademarks “Celquat L 200” and “Celquat H 100” from National Starch & Chemical Company.

Useful cationic cellulose polymers are, per se, generally known. Exemplary cationic cellulose polymers useful in the present inventive compositions exhibit generally a viscosity of about 1,000 cps (as taken from a product specification of Celquat H-100; measured as 2% solids in water using an RVF Brookfield Viscometer, #2 spindle at 20 rpm and 21° C.).

The film-forming polymer may be present in any amount which is found effective in forming a film on a hard surface being treated. It will be understood that this such a minimum amount will vary widely, and is in part dependent upon the molecular weight of the film forming polymer utilized in a formulation, but desirably at least about 0.001% wt. should be present. More preferably the film forming polymer comprises from 0.001% wt. to 10% wt. of the compositions of which it forms a part.

According to the first and second aspects of the invention, the compositions necessarily include (d) one or more surfactants which provide a further detersive benefit to the compositions.

Useful surfactants which provide a further detersive benefit which may be present in the inventive compositions include detersive surfactants particularly selected from nonionic, cationic and amphoteric surfactants.

Suitable nonionic surfactants include, inter alia, condensation products of alkylene oxide groups with an organic hydrophobic compound, such as an aliphatic compound or with an alkyl aromatic compound. The nonionic synthetic organic detergents generally are the condensation products of an organic aliphatic or alkyl aromatic hydrophobic compound and hydrophilic ethylene oxide groups. Practically any hydrophobic compound having a carboxy, hydroxy, amido, or amino group with a free hydrogen attached to the nitrogen can be condensed with ethylene oxide or with the polyhydration product thereof, polyethylene glycol, to form a water soluble nonionic detergent. Further, the length of the polyethenoxy hydrophobic and hydrophilic elements may be varied to adjust these properties.

One example of such a nonionic surfactant is the condensation product of one mole of an alkyl phenol having an alkyl group containing from 6 to 12 carbon atoms with from about 5 to 25 moles of an alkylene oxide. Another example of such a nonionic surfactant is the condensation product of one mole of an aliphatic alcohol which may be a primary, secondary or tertiary alcohol having from 6 to 18 carbon atoms with from 1 to about 10 moles of alkylene oxide. Preferred alkylene oxides are ethylene oxides or propylene oxides which may be present singly, or may be both present.

Preferred nonionic surfactants include primary and secondary linear and branched alcohol ethoxylates, such as those based on C₆-C₁₈ alcohols which further include an average of from 2 to 80 moles of ethoxylation per mol of alcohol Particularly preferred nonionic surfactants are C₁₁ linear primary alcohol ethoxylates averaging about 9 moles of ethylene oxide per mole of alcohol. These surfactants are available, for example, under the commercial name of Neodol 1-9, (from Shell Chemical Company, Houston, Tex.), or in the Genapol® series of linear alcohol ethoxylates, particularly Genapol® 26-L-60 or GenapolS 26-L-80 (from Clariant Corp., Charlotte, N.C.). A further class of nonionic surfactants which are advantageously present in the inventive compositions are those presently marketed under the Genapol® tradename.

A further particularly useful and preferred alcohol ethoxylate is Genapol® UD-079 which is described to be a C, linear alcohol condensed with 7 moles of ethylene oxide to form a nonionic surfactant.

It is to be understood that other nonionic surfactants other than those described above may also be used. By way of illustration, and not by way of limitation, examples include secondary C₁₂-C₁₅ alcohol ethoxylates, including those which have from about 3 to about 10 moles of ethoxylation. Such are available in the Tergitol® series of nonionic surfactants (Union Carbide Corp., Danbury, Conn.), particularly those in the Tergitol® “15-S-” series. Further exemplary nonionic surfactants include linear primary C₁₁-C₁₅ alcohol ethoxylates, including those which have from about 3 to about 10 moles of ethoxylation. Such are available in the Neodol® series of nonionic surfactants (Shell Chemical Co.)

A further class of nonionic surfactants which may find use in the present inventive compositions include ethoxylated octyl and nonyl phenols include those having one of the following general structural formulas:

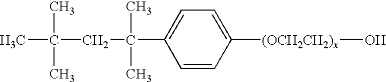

or,

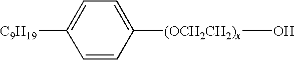

in which the C₉H₁₉ group in the latter formula is a mixture of branched chained isomers, and x indicates an average number of ethoxy units in the side chain. Particularly suitable non-ionic ethoxylated octyl and nonyl phenols include those having from about 7 to about 13 ethoxy groups. Such compounds are commercially available under the trade name Triton® X (Union Carbide, Danbury Conn.), as well as under the tradename Igepalo (Rhodia, Princeton, N.J.). One exemplary and particularly preferred nonylphenol ethoxylate is Igepal® CO-630.

One useful class of surfactants include amine oxide compounds. Exemplary useful amine oxide compounds may be defined as one or more of the following of the four general classes:

(1) Alkyl di (lower alkyl) amine oxides in which the alkyl group has about 6-24, and preferably 8-18 carbon atoms, and can be straight or branched chain, saturated or unsaturated. The lower alkyl groups include between 1 and 7 carbon atoms, but preferably each include 1-3 carbon atoms. Examples include octyl dimethyl amine oxide, lauryl dimethyl amine oxide, myristyl dimethyl amine oxide, and those in which the alkyl group is a mixture of different amine oxides, such as dimethyl cocoamine oxide, dimethyl (hydrogenated tallow) amine oxide, and myristyl/palmityl dimethyl amine oxide;

(2) Alkyl di (hydroxy lower alkyl) amine oxides in which the alkyl group has about 6-22, and preferably 8-18 carbon atoms, and can be straight or branched chain, saturated or unsaturated. Examples include bis-(2-hydroxyethyl) cocoamine oxide, bis-(2-hydroxyethyl) tallowamine oxide; and bis-(2-hydroxyethyl) stearylamine oxide;

(3) Alkylamidopropyl di(lower alkyl) amine oxides in which the alkyl group has about 10-20, and preferably 12-16 carbon atoms, and can be straight or branched chain, saturated or unsaturated. Examples are cocoamidopropyl dimethyl amine oxide and tallowamidopropyl dimethyl amine oxide; and

(4) Alkylmorpholine oxides in which the alkyl group has about 10-20, and preferably 12-16 carbon atoms, and can be straight or branched chain, saturated or unsaturated.

While these amine oxides recited above may be used, preferred are amine oxides which may be represented by the following structural representation:

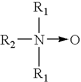

wherein
each R₁ independently is a straight chained C₁-C₄ alkyl group, preferably both R₁ are methyl groups; and,
R₂ is a straight chained C₆-C₂₂ alkyl group, preferably is C₆-C₁₆ alkyl group, most preferably is a C₈₋₁₀ alkyl group, especially a C₈ alkyl group;

Each of the alkyl groups may be linear or branched, but most preferably are linear. Most preferably the amine oxide constituent is lauryl dimethyl amine oxide. Technical grade mixtures of two or more amine oxides may be used, wherein amine oxides of varying chains of the R₂ group are present. Preferably, the amine oxides used in the present invention include R₂ groups which comprise at least 50% wt., preferably at least 75% wt. of C₈ alkyl group.

Exemplary and preferred amine oxide compounds include N-alkyl dimethyl amine oxides, particularly octyl dimethyl amine oxides as well as lauryl dimethyl amine oxide. These amine oxide compounds are available as surfactants from McIntyre Group Ltd. under the name Mackamine® C-8 which is described as a 40% by weight active solution of octyl dimethyl amine oxide, as well as from Stepan Co., under the tradename Ammonyx® LO which is described to be as a 30% wt. active solution of lauryl dimethyl amine oxide.

A further class of materials surfactants which may be advantageously included in the inventive compositions are alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

One group of such useful nonionic surfactants containing the characteristic alkylene oxide blocks are those which may be generally represented by the formula (A):

HO-(EO)ₓ(PO)_{y}(EO)_{z}—H (A)

where
EO represents ethylene oxide,
PO represents propylene oxide,
y equals at least 15,
(EO)_{x+z} equals 20 to 50% of the total weight of said compounds, and,
the total molecular weight is preferably in the range of about 2000 to 15,000.

Another group of nonionic surfactants appropriate for use in the new compositions can be represented by the formula (B):

R-(EO,PO)ₐ(EO,PO)_{b}—H (B)

wherein R is an alkyl, aryl or aralkyl group, where the R group contains 1 to 20 carbon atoms, the weight percent of EO is within the range of 0 to 45% in one of the blocks a, b, and within the range of 60 to 100% in the other of the blocks a, b, and the total number of moles of combined EO and PO is in the range of 6 to 125 moles, with 1 to 50 moles in the PO rich block and 5 to 100 moles in the EO rich block.

Further nonionic surfactants which in general are encompassed by Formula B include butoxy derivatives of propylene oxide/ethylene oxide block polymers having molecular weights within the range of about 2000-5000.

Still further useful nonionic surfactants containing polymeric butoxy (BO) groups can be represented by formula (C) as follows:

RO—(BO)ₙ(EO)ₓ—H (C)

wherein R is an alkyl group containing 1 to 20 carbon atoms,
n is about 5-15 and x is about 5-15.

Also useful as the nonionic block copolymer surfactants, which also include polymeric butoxy groups, are those which may be represented by the following formula (D):

HO-(EO)ₓ(BO)ₙ(EO)_{y}—H (D)

wherein
n is about 5-15, preferably about 15,
x is about 5-15, preferably about 15, and
y is about 5-15, preferably about 15.

Still further useful nonionic block copolymer surfactants include ethoxylated derivatives of propoxylated ethylene diamine, which may be represented by the following formula:

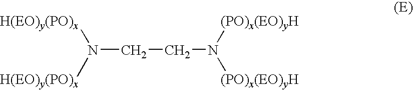

where (EO) represents ethoxy,
(PO) represents propoxy,

the amount of (PO)ₓ is such as to provide a molecular weight prior to ethoxylation of about 300 to 7500, and the amount of (EO)_{y} is such as to provide about 20% to 90% of the total weight of said compound.

Of these, the most preferred are those which are represented by formula (A) above; specific examples of which include those materials presently commercially available under the tradename “Pluronic®”, and in particular the Pluronic® F series, Pluronic®) L series, Pluronic® P series, as well as in the Pluronic® R series, each of which are generally described to be block copolymers of propylene oxide and is ethylene oxide. Generally those of the Pluronic®) L series and the Pluronic®) R series are preferred as these are supplied in liquid form by the manufacturer and are readily formulated into the present inventive compositions. These are also available in a wide range of HLB values, and those having HLB values in the range of 1.0-23.0 may be used, although those with intermediate HLB values such as from about 12.0-18.0 are found to be particularly advantageous. These materials are presently commercially available from BASF AG (Ludwigshafen, Germany) as well as from BASF Corp. (Mt. Olive Township, New Jersey).

A further class of surfactants which may be advantageously included in the inventive compositions are carboxylates, particularly one or more alkylpolyoxycarboxylates including alkyletherpolyoxycarboxylates, or alkylarylpolycarboxylates. Exemplary alkylpolyoxycarboxylates and alkylarylpolycarboxylates include alkyl- and alkylaryl-carboxylates which include those which may be represented by the general formula:

R—COO⁻M⁺

wherein R is a straight or branched hydrocarbon chain containing from about 9 to 21 carbon atoms, and which may also include an aromatic ring, especially a phenyl group as part of the hydrocarbon chain, and M is a metal or ammonium ion.

Further examples of particularly useful carboxylate surfactants include compounds according to the formula:

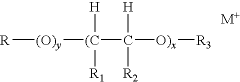

where:
R is a C₄-C₂₂ linear or branched alkyl group which may optionally include at least one aryl group, preferably C₈-C₁₁ linear or branched alkyl group which may include at least one aryl group, and yet more preferably a C₁₂₋₁₅ linear or branched alkyl group which may include at least one aryl group;
x is an integer from 1 to 24,
y is 0 or 1,
R₁, R₂ and R₃ are each individually a group selected from H, lower alkyl radicals including methyl and ethyl radicals, carboxylate radicals including acetate and propionate radicals, succinate radicals, hydroxysuccinate radicals, or mixtures thereof wherein at least one R₁, R₂ or R₃ is a carboxylate radical; and,

M⁺ is a counterion including an alkali metal counterion (i.e., sodium, potassium) or ammonium counterion.

Free acid forms of the alkylethercarboxylate compounds noted above may also be used.

Examples of such presently available commercial preparations include SURFINE WLG (Finetex Inc., Elmwood Park N.J.), SANDOPAN DTC (Clariant Chem. Co., Charlotte N.C.) in salt forms, and in free acid forms include those marketed under the tradename NEODOX (Shell Chemical Co., Houston Tex.). One particularly preferred carboxylate is one which is represented by the formula:

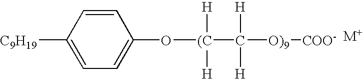

Such a material is presently commercially available under the tradename Emcol®, and specifically as Emcol® CNP-110.

Other useful exemplary nonionic block copolymers based on a polymeric ethoxy/propoxy units which may also be used include those presently commercially available in the Poly-Tergent® E, and Poly-Tergent® P series of materials from Olin Chemicals Corp., (Stamford Conn.). These are described to be nonionic surfactants based on ethoxy/propoxy block copolymers, conveniently available in a liquid form from its supplier.

It is to be understood that these nonionic surfactants based on polymeric alkylene oxide block copolymers may be used singly or in mixtures of two or more such compounds.

Amphoteric surfactants, also known as zwitterionic surfactants, contain both cationic and anionic hydrophilic groups on the same molecule at a relatively wide range of pHs. The typical cationic group is a quaternary ammonium group, although other positively charged groups, like sulfonium groups, can also be used. The typical anionic hydrophilic groups are carboxylates and sulfonates, although other groups like sulfates, etc., can be used. Amphoteric surfactants also include betaine and sulphobetaine surfactants, derivatives thereof, and mixtures thereof wherein the molecule contains both basic and acidic groups which form an inner salt giving the molecule both cationic and anionic hydrophilic groups over a broad range of pH values, as well as mono- and diacetates, glycinates, imidazolines and their derivatives, mono- and diproprionates, hydroxy sultaines, and taurates.

When the compositions of the present invention contain one or more further detersive surfactants, these may be present in any amount which is found to provide a beneficial detersive effect. Generally, these one or more further detersive surfactants do not comprise more than 12% wt. (on an actives weight basis) of the inventive compositions. When included such one or more further detersive surfactants are advantageously present in an amount from 0.001-10% wt., preferably are present from 0.01-8% wt., but still more preferably are included in amounts of from 0.1-8% wt.

According to the first and third aspects of the invention, the compositions necessarily include (e) one or more organic solvents.

Exemplary organic solvents which may be included in the inventive compositions include those which are at least partially water-miscible such as alcohols (e.g., low molecular weight alcohols, such as, for example, ethanol, propanol, isopropanol, and the like), glycols (such as, for example, ethylene glycol, propylene glycol, hexylene glycol, and the like), water-miscible ethers (e.g. diethylene glycol diethylether, diethylene glycol dimethylether, propylene glycol dimethylether), water-miscible glycol ether (e.g. propylene glycol monomethylether, propylene glycol mono ethylether, propylene glycol monopropylether, propylene glycol monobutylether, ethylene glycol monobutylether, dipropylene glycol monomethylether, diethyleneglycol monobutylether), lower esters of monoalkylethers of ethylene glycol or propylene glycol (e.g. propylene glycol monomethyl ether acetate) all commercially available such as from Union Carbide (Danbury, Conn.), Dow Chemical Co. (Midland, Mich.) or Hoescht (Germany). Mixtures of several organic solvents can also be used.

Preferred as solvents in this invention are the glycol ethers having the general structure Rₐ—R_{b}—OH, wherein Rₐ is an alkoxy of 1 to 20 carbon atoms, or aryloxy of at least 6 carbon atoms, and R_{b} is an ether condensate of propylene glycol and/or ethylene glycol having from one to ten glycol monomer units. Preferred are glycol ethers having one to five glycol monomer units. These are C₃-C₂₀ glycol ethers. Examples of more preferred solvents include propylene glycol methyl ether, dipropylene glycol methyl ether, tripropylene glycol methyl ether, propylene glycol isobutyl ether, ethylene glycol methyl ether, ethylene glycol ethyl ether, ethylene glycol butyl ether, diethylene glycol phenyl ether, propylene glycol phenol ether, and mixtures thereof.

The compositions are largely aqueous in nature, and comprise as a further necessary constituent (f) water. Water is added to order to provide to 100% by weight of the compositions of the invention. The water may be tap water, but is preferably distilled and is most preferably deionized water. If the water is tap water, it is preferably substantially free of any undesirable impurities such as organics or inorganics, especially minerals salts which are present in hard water which may thus undesirably interfere with the operation of the constituents present in the aqueous compositions according to the invention.

As discussed previously, the inventive compositions may comprise one or more conventional optional additives. By way of non-limiting example, these include: pH adjusting agents and pH buffers including organic and inorganic salts; non-aqueous solvents, perfumes, perfume carriers, optical brighteners, coloring agents such as dyes and pigments, opacifying agents, hydrotropes, antifoaming agents, viscosity modifying agents such as thickeners, enzymes, anti-spotting agents, anti-oxidants, anti-corrosion agents as well as others not specifically elucidated here. These ingredients may be present in any combinations and in any suitable amount that is sufficient for imparting the desired properties to the compositions. These one or more conventional additives, when present, should be present in minor amounts, preferably in total comprise less than about 5% by weight (on an active weight basis) of the compositions, and desirably less than about 3% wt.

Such materials described above are known to the art, including those described in McCutcheon's Emulsifiers and Detergents (Vol. 1), McCutcheon's Functional Materials (Vol. 2), North American Edition, 2001; Kirk-Othmer, Encyclopedia of Chemical Technology, 4th Ed., Vol. 23, the contents of which are herein incorporated by reference For any particular composition, any optional constituents should be compatible with the other ingredients present.

The aqueous compositions according to the invention are desirably provided as a ready to use product which may be directly applied to a hard surface. Hard surfaces which are to be particularly denoted are lavatory fixtures, lavatory appliances (toilets, bidets, shower stalls, bathtubs and bathing appliances), wall and flooring surfaces especially those which include refractory materials and the like. Further hard surfaces which are particularly denoted are those associated with kitchen environments and other environments associated with food preparation. Hard surfaces which are those associated with hospital environments, medical laboratories and medical treatment environments. Such hard surfaces described above are to be understood as being recited by way of illustration and not be way of limitation.

The composition provided according to the invention can be desirably provided as a ready to use product in a manually operated spray dispensing container, or may be supplied in aerosolized product wherein it is discharged from a pressurized aerosol container. Known art propellants such as liquid propellants based on chlorofluorocarbons or propellants of the non-liquid form, i.e., pressurized gases, including carbon dioxide, air, nitrogen, as well as others, may be used, even though it is realized that the former chlorofluorocarbons are not generally further used due to environmental considerations. In such an application, the cleaning composition is dispensed by activating the release nozzle of said aerosol type container onto the stain and/or stain area, and in accordance with a manner as above-described a stain is treated and removed.

The composition according to the invention is ideally suited for use in a consumer “spray and wipe” application. In such an application, the consumer generally applies an effective amount of the cleaning composition using the pump and within a few moments thereafter, wipes off the treated area with a rag, towel, or sponge, usually a disposable paper towel or sponge. In certain applications, however, especially where undesirable stain deposits are heavy, the cleaning composition according to the invention may be left on the stained area until it has effectively loosened the stain deposits after which it may then be wiped off, rinsed off, or otherwise removed. For particularly heavy deposits of such undesired stains, multiple applications may also be used. Where thorough disinfection is a primary consideration, it may be desired to apply the inventive compositions to the hard surface being treated and to permit the composition to remain on the hard surface for several minutes (2-10 min.) prior to rinsing or wiping the composition from the hard surface. It is also contemplated that the inventive compositions be applied to a hard surface without subsequently wiping or rinsing the treated hard surface.

Whereas the compositions of the present invention are intended to be used in the types of liquid forms described, nothing in this specification shall be understood as to limit the use of the composition according to the invention with a further amount of water to form a cleaning solution therefrom. In such a proposed diluted cleaning solution, the greater the proportion of water added to form said cleaning dilution will, the greater may be the reduction of the rate and/or efficacy of the thus formed cleaning solution. Accordingly, longer residence times upon the stain to effect their loosening and/or the usage of greater amounts may be necessitated. Conversely, nothing in the specification shall be also understood to limit the forming of a “super-concentrated” cleaning composition based upon the composition described above. Such a super-concentrated ingredient composition is essentially the same as the cleaning compositions described above except in that they include a lesser amount of water.

The composition of the present invention, whether as described herein or in a concentrate or super concentrate form, can also be applied to a hard surface by using a wet wipe. The wipe can be of a woven or non-woven nature. Fabric substrates can include nonwoven or woven pouches, sponges, in the form of abrasive or non-abrasive cleaning pads. Such fabrics are known commercially in this field and are often referred to as wipes. Such substrates can be resin bonded, hydroentangled, thermally bonded, meltblown, needlepunched, or any combination of the former.

The nonwoven fabrics may be a combination of wood pulp fibers and textile length synthetic fibers formed by well known dry-form or wet-lay processes. Synthetic fibers such as rayon, nylon, orlon and polyester as well as blends thereof can be employed. The wood pulp fibers should comprise about 30 to about 60 percent by weight of the nonwoven fabric, preferably about 55 to about 60 percent by weight, the remainder being synthetic fibers. The wood pulp fibers provide for absorbency, abrasion and soil retention whereas the synthetic fibers provide for substrate strength and resiliency.

The substrate of the wipe may also be a film forming material such as a water soluble polymer. Such self-supporting film substrates may be sandwiched between layers of fabric substrates and heat sealed to form a useful substrate. The free standing films can be extruded utilizing standard equipment to devolatilize the blend. Casting technology can be used to form and dry films or a liquid blend can be saturated into a carrier and then dried in a variety of known methods.

The compositions of the present invention are absorbed onto the wipe to form a saturated wipe. The wipe can then be sealed individually in a pouch which can then be opened when needed or a multitude of wipes can be placed in a container for use on an as needed basis. The container, when closed, sufficiently sealed to prevent evaporation of any components from the compositions.

The following examples below illustrate exemplary and preferred formulations of the concentrate composition according to the instant invention. It is to be understood that these examples are presented by means of illustration only and that further useful formulations fall within the scope of this invention and the claims may be readily produced by one skilled in the art and not deviate from the scope and spirit of the invention.

Throughout this specification and in the accompanying claims, weight percents of any constituent are to be understood as the weight percent of the active portion of the referenced constituent, unless otherwise indicated.

### EXAMPLES

The following examples illustrate the formulation and performance of various compositions of the invention, as well as certain particularly preferred embodiments of the invention.

Exemplary formulations illustrating certain preferred embodiments of the inventive compositions and described in more detail in Table 1 below were formulated generally in accordance with the following protocol. The weight percentages indicated the “as supplied” weights of the named constituent.

Into a suitably sized vessel, a measured amount of water was provided after which the constituents were added in no specific or uniform sequence, which indicated that the order of addition of the constituents was not critical. All of the constituents were supplied at room temperature, and any remaining amount of water was added thereafter. Certain of the nonionic surfactants if gels at room temperature were first preheated to render them pourable liquids prior to addition and mixing. Mixing of the constituents was achieved by the use of a mechanical stirrer with a small diameter propeller at the end of its rotating shaft. Mixing, which generally lasted from 5 minutes to 120 minutes was maintained until the particular exemplary formulation appeared to be homogeneous. The exemplary compositions were readily pourable, and retained well mixed characteristics (i.e., stable mixtures) upon standing for extended periods. The compositions of the example formulations are listed on Table 1.

TABLE 1

| | E1 | E2 | E3 | E4 | E5 | E6 | E7 | E8 |
|---|---|---|---|---|---|---|---|---|
| BTC 8358 | 0.05625 | 0.05625 | 0.05625 | 0.05625 | 0.05625 | 0.027 | 0.027 | 0.027 |
| BTC 65NF | | | | | | 0.172 | 0.172 | 0.172 |
| Fluorad FC-171 | 0.01 | 0.01 | | | | 0.1 | 0.1 | 0.1 |
| Fluorad FC-135 | | | 0.02 | | | | | |
| Zonyl FSN 100 | | | | 0.01 | | | | |
| Zonyl FSD | | | | | 0.033 | | | |
| Genapol 26-L- | | | | | | | 0.5 | 0.5 |
| 80 | | | | | | | | |
| Ammonyx CDO | | | | | | | 0.5 | 0.5 |
| Dowanol DPnB | | | | | | 2.1 | | 2.1 |
| Na₂CO₃ | | | | | | 0.084 | 0.084 | 0.084 |
| Gafquat 734 | 0.3 | 0.01 | 0.1 | 0.1 | 0.1 | 0.1 | 0.1 | 0.1 |
| DI water | q.s | q.s. | q.s. | q.s. | q.s. | q.s. | q.s. | q.s. |

| | E9 | E10 | E11 | E12 | E13 | E14 | E15 |
|---|---|---|---|---|---|---|---|
| BTC 8358 | 0.05625 | 0.05625 | 0.05625 | 0.05625 | 0.05625 | 0.05625 | 0.05625 |
| Fluorad FC-171 | 0.01 | 0.01 | 0.01 | 0.01 | 0.01 | 0.01 | |
| Fluorad FC-135 | | | | | | | 0.02 |
| PVP K-120 | 0.15 | 0.10 | 0.05 | | | | 0.05 |
| PVP K-30 | | | | 0.05 | | | |
| PVP K-15 | | | | | 0.05 | | |
| PVP K-60 | | | | | | 0.11 | |
| DI water | q.s. | q.s. | q.s. | q.s. | q.s. | q.s. | q.s. |

| | E16 | E17 | E18 | E19 | E20 | E21 | E22 | E23 |
|---|---|---|---|---|---|---|---|---|
| BTC 8358 | 0.05625 | 0.05625 | 0.027 | 0.027 | 0.027 | 0.027 | 0.027 | 0.05625 |
| BTC 65NF | | | 0.172 | 0.172 | 0.172 | 0.172 | 0.172 | |
| Fluorad FC-171 | | | 0.1 | 0.1 | 0.1 | 0.1 | 0.1 | 0.01 |
| Fluorad FC-135 | | | | | | | | |
| Zonyl FSN 100 | 0.01 | | | | | | | |
| Zonyl FSD | | 0.033 | | | | | | |
| Genapol 26-L-80 | | | 0.5 | 0.5 | 0.5 | | 0.5 | |
| Ammonyx CDO | | | 0.5 | 0.5 | 0.5 | | 0.5 | |
| Dowanol DPnB | | | 2.1 | 2.1 | 2.1 | 2.1 | | |
| Na₂CO₃ | | | 0.084 | 0.084 | 0.084 | 0.084 | 0.084 | |
| PVP K-120 | 0.05 | 0.05 | 0.05 | 0.1 | 0.15 | 0.05 | 0.05 | |
| PVP K-30 | | | | | | | | 0.15 |
| DI water | q.s. | q.s. | q.s. | q.s. | q.s. | q.s. | q.s. | |

| | E24 | E25 | E26 | E27 | E28 | E29 | E30 |
|---|---|---|---|---|---|---|---|
| BTC 8358 | 0.05625 | 0.05625 | 0.05625 | 0.05625 | 0.05625 | 0.05625 | 0.05625 |
| Fluorad FC-171 | 0.01 | 0.01 | 0.01 | 0.01 | 0.01 | 0.01 | 0.01 |
| Carbowax 8000 | 0.05 | | | | | | |
| Carbowax 300 | | | | | 0.05 | | |
| Carbowax 600 | | 0.05 | 0.10 | 0.15 | | | |
| Carbowax 1000 | | | | | | 0.05 | |
| Carbowax 1450 | | | | | | | 0.05 |
| Carbowax 4000 | | | | | | | |
| DI water | q.s. | q.s. | q.s. | q.s. | q.s. | q.s. | q.s. |
| | E31 | E32 | E33 | E34 | E35 | E36 | E37 |
| BTC 8358 | 0.05625 | 0.027 | 0.027 | 0.027 | 0.05625 | 0.05625 | 0.05625 |
| BTC 65NF | | 0.172 | 0.172 | 0.172 | | | |
| Fluorad FC-171 | 0.01 | 0.1 | 0.1 | 0.1 | | | |
| Fluorad FC-135 | | | | | 0.02 | | |
| Zonyl FSN 100 | | | | | | 0.01 | |
| Zonyl FSD | | | | | | | 0.033 |
| Genapol 26-L-80 | | | 0.5 | 0.5 | | | |
| Ammonyx CDO | | | 0.5 | 0.5 | | | |
| Dowanol DPnB | | 2.1 | | 2.1 | | | |
| Na₂CO₃ | | 0.084 | 0.084 | 0.084 | | | |
| Carbowax 600 | | 0.05 | 0.05 | 0.05 | 0.05 | 0.05 | 0.05 |
| Carbowax 4000 | 0.05 | | | | | | |
| DI water | q.s. | q.s. | q.s. | q.s. | q.s. | q.s. | q.s. |
| | E38 | E39 | E40 | E41 | E42 | E43 | E44 |
| BTC 8358 | 0.05625 | 0.027 | 0.027 | 0.27 | 0.05625 | 0.05625 | 0.05625 |
| BTC 65NF | | 0.172 | 0.172 | 0.172 | | | |
| Fluorad FC-171 | 0.01 | 0.1 | 0.1 | 0.1 | | | |
| Fluorad FC-135 | | | | | 0.02 | | |
| Zonyl FSN 100 | | | | | | 0.01 | |
| Zonyl FSD | | | | | | | 0.033 |
| Genapol 26-L-80 | | | 0.5 | 0.5 | | | |
| Ammonyx CDO | | | 0.5 | 0.5 | | | |
| Dowanol DPnB | | 2.1 | | 2.1 | | | |
| Na₂CO₃ | | 0.084 | 0.084 | 0.084 | | | |
| Glucopon 425N | 0.1 | 0.1 | 0.1 | 0.1 | 0.1 | 0.1 | 0.1 |
| DI water | q.s. | q.s. | q.s. | q.s. | q.s. | q.s. | q.s. |

| | E45 | E46 | E47 | E48 | E49 | E50 |
|---|---|---|---|---|---|---|
| BTC 8358 | 0.05625 | 0.05625 | 0.05625 | 0.05625 | 0.05625 | 0.05625 |
| Fluorad FC-171 | 0.01 | | | | | 0.1 |
| Fluorad FC-135 | | 0.02 | | | | |
| Zonyl FSO 100 | | | 0.01 | | | |
| Zonyl FSN 100 | | | | 0.01 | | |
| Zonyl FSD | | | | | 0.033 | |
| Luviskol plus | 0.125 | 0.125 | 0.125 | 0.125 | 0.125 | 0.125 |
| DI water | q.s | q.s. | q.s. | q.s. | q.s. | q.s. |
| | E51 | E52 | E53 | E54 | E55 | E56 |
| BTC 8358 | 0.05625 | 0.05625 | 0.05625 | 0.027 | 0.027 | 0.027 |
| BTC 65NF | | | | 0.172 | 0.172 | 0.172 |
| Fluorad FC-171 | 0.1 | 0.1 | 0.01 | 0.1 | 0.1 | 0.1 |
| Genapol 26-L-80 | | | | | 0.5 | 0.5 |
| Ammonyx CDO | | | | | 0.5 | 0.5 |
| Dowanol DPnB | | | | 2.1 | | 2.1 |
| Na₂CO₃ | | | | 0.084 | 0.084 | 0.084 |
| Luviskol plus | 0.25 | 0.50 | 1.25 | 0.125 | 0.25 | 0.50 |
| DI water | q.s. | q.s. | q.s. | q.s. | q.s. | q.s. |

| | E57 | E58 | E59 | E60 | E61 | E62 | E63 |
|---|---|---|---|---|---|---|---|
| BTC 8358 | 0.05625 | 0.05625 | 0.05625 | 0.05625 | 0.027 | 0.027 | 0.027 |
| BTC 65NF | | | | | 0.172 | 0.172 | 0.172 |
| Fluorad FC-171 | 0.01 | | | | 0.1 | 0.1 | 0.1 |
| Fluorad FC-135 | | 0.02 | | | | | |
| Zonyl FSN 100 | | | 0.01 | | | | |
| Zonyl FSD | | | | 0.033 | | | |
| Genapol 26-L-80 | | | | | | 0.5 | 0.5 |
| Ammonyx CDO | | | | | | 0.5 | 0.5 |
| Dowanol DPnB | | | | | 2.1 | | 2.1 |
| Na₂CO₃ | | | | | 0.084 | 0.084 | 0.084 |
| Polycar PVP/VA | 0.053 | 0.053 | 0.053 | 0.053 | 0.053 | 0.053 | 0.053 |
| S-630 | | | | | | | |
| DI water | q.s | q.s. | q.s. | q.s. | q.s. | q.s. | q.s. |
| | E64 | E65 | E66 | E67 | E68 | E69 | E70 |
| BTC 8358 | 0.05625 | 0.05625 | 0.05625 | 0.05625 | 0.027 | 0.027 | 0.027 |
| BTC 65NF | | | | | 0.172 | 0.172 | 0.172 |
| Fluorad FC-171 | 0.01 | | | | 0.1 | 0.1 | 0.1 |
| Fluorad FC-135 | | 0.02 | | | | | |
| Zonyl FSN 100 | | | 0.01 | | | | |
| Zonyl FSD | | | | 0.033 | | | |
| Genapol 26-L-80 | | | | | | 0.5 | 0.5 |
| Ammonyx CDO | | | | | | 0.5 | 0.5 |
| Dowanol DPnB | | | | | 2.1 | | 2.1 |
| Na₂CO₃ | | | | | 0.084 | 0.084 | 0.084 |
| Advantage HC-37 | 0.143 | 0.143 | 0.143 | 0.143 | 0.143 | 0.25 | 0.50 |
| DI water | q.s. | q.s. | q.s. | q.s. | q.s. | q.s. | q.s. |
| | E71 | E72 | E73 | E74 | E75 | E76 | E77 |
| BTC 8358 | 0.05625 | 0.05625 | 0.05625 | 0.05625 | 0.027 | 0.027 | 0.027 |
| BTC 65NF | | | | | 0.172 | 0.172 | 0.172 |
| Fluorad FC-171 | 0.01 | | | | 0.1 | 0.1 | 0.1 |
| Fluorad FC-135 | | 0.02 | | | | | |
| Zonyl FSN 100 | | | 0.01 | | | | |
| Zonyl FSD | | | | 0.033 | | | |
| Genapol 26-L-80 | | | | | | 0.5 | 0.5 |
| Ammonyx CDO | | | | | | 0.5 | 0.5 |
| Dowanol DPnB | | | | | 2.1 | | 2.1 |
| Na₂CO₃ | | | | | 0.084 | 0.084 | 0.084 |
| Airvol 203 | 0.05 | 0.05 | 0.05 | 0.05 | 0.05 | 0.05 | 0.05 |
| DI water | q.s. | q.s. | q.s. | q.s. | q.s. | q.s. | q.s. |

| | E78 | E79 | E80 | E81 |
|---|---|---|---|---|
| BTC 8358 | 0.05625 | 0.05625 | 0.05625 | 0.05625 |
| BTC 65NF | | | | |
| Fluorad FC-171 | 0.01 | 0.03 | | |
| Fluorad FC-135 | | | 0.02 | |
| Zonyl FSN 100 | | | | 0.01 |
| Celquat H-100 | 0.05376 | 0.05376 | 0.05376 | 0.05376 |
| DI water | q.s | q.s. | q.s. | q.s. |
| | E82 | E83 | E84 | E85 |
| BTC 8358 | 0.05625 | 0.027 | 0.027 | 0.027 |
| BTC 65NF | | 0.172 | 0.172 | 0.172 |
| Fluorad FC-171 | | 0.1 | 0.1 | 0.1 |
| Zonyl FSD | 0.033 | | | |
| Genapol 26-L-80 | | | 0.5 | 0.5 |
| Ammonyx CDO | | | 0.5 | 0.5 |
| Dowanol DPnB | | 2.1 | | 2.1 |
| Na₂CO₃ | | 0.084 | 0.084 | 0.084 |
| Celquat H-100 | 0.05376 | 0.05376 | 0.05376 | 0.05376 |
| DI water | q.s. | q.s. | q.s. | q.s. |

| | E86 | E87 | E88 | E89 | E90 | E91 |
|---|---|---|---|---|---|---|
| BTC 8358 | 0.05625 | 0.05625 | 0.05625 | 0.05625 | 0.05625 | 0.05625 |
| Repearl FS-141 | 0.03 | 0.06 | 0.09 | 0.03 | 0.03 | 0.03 |
| Polyox WSR N-3000 | | | | 0.05 | | |
| Gafquat 734 | | | | | 0.1 | |
| Carbowax 4000 | | | | | | 0.05 |
| DI water | q.s | q.s. | q.s. | q.s. | q.s. | q.s. |

| | E92 | E93 | E94 | E95 | E96 |
|---|---|---|---|---|---|
| BTC 8358 | 0.05625 | 0.05625 | 0.05625 | 0.05625 | 0.05625 |
| Repearl FS-141 | 0.03 | 0.03 | 0.03 | 0.03 | 0.03 |
| PVP K-120 | 0.05 | | | | |
| Glucopon 425N | | 0.1 | | | |
| Luviskol plus | | | 0.125 | | |
| Advantage HC-37 | | | | 0.1428 | |
| Airvol 203 | | | | | 0.05 |
| DI water | q.s | q.s. | q.s. | q.s. | q.s. |

| | E97 | E98 | E99 | E100 |
|---|---|---|---|---|
| BTC 8358 | 0.05625 | 0.05625 | 0.05625 | 0.05625 |
| Repearl FS-141 | 0.03 | 0.03 | | |
| Repearl FS-131 | | | 0.03 | |
| Repearl FS-111 | | | | 0.03 |
| Airvol 203 | | | 0.05 | 0.05 |
| PVP/VA S-360 | 0.053 | | | |
| Celquat H-100 | | 0.05376 | | |
| DI water | q.s. | q.s. | q.s. | q.s. |

| | E101 | E102 | E103 | E104 | E105 |
|---|---|---|---|---|---|
| BTC 8358(82%) | 0.055 | 0.055 | 0.055 | 0.055 | 0.055 |
| Lodyne S-106A(30%) | 0.03 | 0.03 | 0.03 | 0.03 | 0.03 |
| Polywax WSR N-3000 | 0.05 | | | | |
| Gafquat 734(50%) | | 0.10 | | | |
| Carbowax 4000 | | | 0.05 | | |
| PVP K-120 | | | | 0.05 | |
| Glucopon 425N | | | | | 0.1 |
| Di water | q.s. | q.s. | q.s. | q.s. | q.s. |
| | E106 | E107 | E108 | E109 | E110 |
| BTC 8358(82%) | 0.055 | 0.055 | 0.055 | 0.055 | 0.055 |
| Lodyne S-106A(30%) | 0.03 | 0.03 | 0.03 | 0.03 | 0.03 |
| Airvol 203 | 0.05 | | | | |
| PVP/VA S-630 | | 0.05 | | | |
| Celquat H-100 | | | 0.05376 | | |
| Luviskol plus | | | | 0.125 | |
| Advantage HC-37 | | | | | 0.1428 |
| Di water | q.s. | q.s. | q.s. | q.s. | q.s. |

As is indicated, to all of the formulations of Table 1 was added sufficient deionized water in “quantum sufficient” to provide 100 parts by weight of a particular formulation.

The identity of the constituents of used to produce various formulations described herein are disclosed on Table 2, below, including the “actives” percentage of each were a constituent was not 100% wt. “actives”.

TABLE 2

| | |
|---|---|
| BTC 8358 | Alkyl dimethyl benzyl ammonium chloride (80% active) from |
| | Stepan Co. |
| BTC 65NF | Alkyl dimethyl benzyl ammonium chloride (50% active) from |
| | Stepan Co. |
| Fluorad FC-171 | Fluorinated alkyl alkoxylate (100% active) from 3M |
| Fluorad FC-135 | Fluorinated alkyl quaternary ammonium iodide (50% active) from |
| | 3M |
| Zonyl FSN 100 | Ethoxylated fluorinated nonionic surfactant (100% active) from |
| | Dupont |
| Zonyl FSD | Ethoxylated fluorinated cationic surfactant (30% active) from |
| | Dupont |
| Repearl FS-111 | Perfluoroalkylethyl carboxylate fluorosurfactant, potassium salt |
| | (30% active) from Mitsubishi Corp. |
| Repearl FS-131 | Perfluoroalkylethyl betaine fluorosurfactant (30% active) from |
| | Mitsubishi Corp. |
| Repearl FS-141 | Perfluoroalkylethyl amine oxide fluorosurfactant (30% active) |
| | from Mitsubishi Corp. |
| Lodyne S-106A | Cationic perfluoroalkyl surfactant having the formula |
| | CF₃(CF₂)₅CH₂CH₂SCH₂CH(OH)CH₂N + (CH₃)₃Cl⁻ (30% active) |
| Genapol 26-L-80 | Linear C₁₂-C₁₆ alcohol ethoxylate, average 9 moles of EO (100 |
| | active) from Clariant |
| Ammonyx CDO | Cocoamidopropylamine oxide (30% active) from Stepan Co. |
| Dowanol DPnB | Dipropylene glycol n-butyl ether (100% active) from Dow |
| | Chemical |
| Na₂CO₃ | Anhydrous sodium carbonate (99% active) from FMC |
| Gafquat 734 | Quaternized polyvinylpyrrolidone/dimethylamino |
| | ethylmethacrylate copolymer (50% active) from ISP Corp. |
| Polyox WSR N- | Water soluble polyethylene oxide resin, having an approximate |
| 3000 | molecular weight of 400,000 from Union Carbide (95% active) |
| Polyox WSR N- | Water soluble polyethylene oxide resin, having an approximately |
| 10 | molecular weight of 100,000 from Union Carbide (95% wt. |
| | active) |
| Polyox WSR 205 | Water soluble polyethylene oxide resin, having an approximately |
| | molecular weight of 600,000 from Union Carbide (95% wt. |
| | active) |
| Polyox WSR 301 | Water soluble polyethylene oxide resin, having an approximately |
| | molecular weight of 4,000,000 from Union Carbide (95% wt. |
| | active) |
| Polyox WSR N- | Water soluble polyethylene oxide resin, having an approximate |
| 12K | molecular weight of 1,000,000 from Union Carbide (95% active) |
| PVP K120 | Polyvinylpyrrolidone, (min. 95% active), 2,000,000-3,000,000 |
| | molecular weight range, from ISP |
| PVP K15 | Polyvinylpyrrolidone, (min. 95% active), 6,000-15,000 molecular |
| | weight range, from ISP |
| PVP K30 | Polyvinylpyrrolidone, (min. 95% active), 40,000-80,000 molecular |
| | weight range, from ISP |
| PVP K60 | Polyvinylpyrrolidone, (min. 45% active), 240,000-450,000 |
| | molecular weight range, from ISP |
| Carbowax 300 | Polyethylene glycol, with average molecular weight of 300, from |
| | Union Carbide |
| Carbowax 600 | Polyethylene glycol, with average molecular weight of 600, from |
| | Union Carbide |
| Carbowax 1000 | Polyethylene glycol, with average molecular weight of 1000, from |
| | Union Carbide |
| Carbowax 1450 | Polyethylene glycol, with average molecular weight of 1450, from |
| | Union Carbide |
| Carbowax 4000 | Polyethylene glycol, with average molecular weight of 4000, from |
| | Union Carbide |
| Carbowax 8000 | Polyethylene glycol, with average molecular weight of 8000, from |
| | Union Carbide |
| Glucopon 425N | Mixture of C₈, C₁₀, C₁₂, C₁₄ and C₁₆ alkyl polyglycoside (50% wt |
| | active) from Henkel Corp. |
| Luviskol plus | Polyvinylcaprolactam (40% actives) from BASF Corp. |
| Polycar PVP/VA | Vinylpyrrolidone/vinylacetate copolymer (60% vinylpyrrolidone |
| S-630 | monomer units; 40% vinylacetate monomer units) (100% active) |
| | from ISP Corp. |
| Advantage HC- | Vinylpyrrolidone/vinylcaprolactam/dimethylaminoethylmethacrylate |
| 37 | terpolymer (molecular weight is 82700; 35% active) from ISP |
| Airvol 203 | Partially hydrolyzed polyvinylalcohol with degree of hydrolysis of |
| | 87.0-89.0% and viscosity of 4% aqueous solution at 20° C. of 5.2-6.2 cps |
| | from Air Products |
| Celquat H-100 | Hydroxyethyl cellulose-dimethyl diallyl ammonium chloride graft |
| | copolymer (93% actives) from National Starch & Chemical |
| DI water | Deionized water |

### Cleaning Efficacy

Certain of the compositions indicated above were evaluated as is and without further dilution under the protocol of ASTM D-4488-89 Annex A5 for particulate soil, which evaluated the efficacy of the cleaning compositions on vinyl tile samples. The soil applied was a particulate soil sample containing natural humus, paraffin oil, used crankcase motor oil, Portland cement, silica, lampblack carbon, iron oxide, bandy black clay, stearic acid, and oleic acid. produced according to the protocol. Each of the soiled test vinyl tile samples were placed into the apparatus and the center of each tile was wetted with a 20 milliliter sample of a test formulation and allowed to stand for 1 minute. When approximately 30 seconds had elapsed, a further 50 milliliter sample was applied to the sponge (water dampened, then wrung to remove excess water) of a Gardner Abrasion Tester apparatus. Thereafter the apparatus was cycled 10 times, which provided 20 strokes of the sponge across the face of each of the vinyl test tiles. The reflectance values of the cleaned samples at 10 cycles were evaluated utilizing a Minolta Chroma Meter CF-110, with Data Processor DP-100, which evaluated spectrophotomic characteristics of the sample. These readings are reported on Table 3.

TABLE 3

| Sample | Percent Reflectance (%) |
|---|---|
| C1 | 51.5* |
| E3 | 53.6 |
| E6 | 76.1 |
| E7 | 75.6 |
| E8 | 77.6 |
| E10 | 52.6 |
| E23 | 52.6 |
| E24 | 47.9 |
| E38 | 55.1 |
| E45 | 51.6 |
| E57 | 50.6 |
| E64 | 49.7 |
| E71 | 50.2 |
| E80 | 67.1 |
| E83 | 64.6 |
| E84 | 64.0 |
| E85 | 61.5 |
| E96 | 51.8 |
| E99 | 57.0 |
| E100 | 57.5 |

*average of 11 samples.

Comparative “C1” was a commercially available cleaning and disinfecting composition, LYSOL Disinfectant Cleaner, “Country Scent” (Reckitt Benckiser Inc., Wayne, N.J.) which was diluted with water at a ratio of composition:water of 1:64 and tested in the manner described above.

With respect to the results reported on Table 3 a value of “100” is indicative of a white (unsoiled) background, and a “0” value is indicative of a black background. As can be seen from the results of Table 3, the cleaning efficacy of the compositions according to the invention provided superior results or were on parity with those of a commercially available cleaning product.

### Surface Protection

The surface repellency of treated tiles was evaluated by determining the contact angle of water on treated tile. The contact angle was determined for a particular formulation by spraying a quantity onto a 22 mm by 22 mm micro cover glass plate and thereafter allowing the formulation to dry on the glass plate. Thereafter the treated plate was provided to a KROSS Tensiometer (Model K12) which automatically evaluated the advancing contact angle according to the Wilhelmy equation:

cos A=F/(L·S)

wherein:
A=contact angle
L=wetted length
F=measured force
S=surface tension of the test liquid (deionized water).

The advancing contact angle was measured for a sample according to the Examples as described on Table 1, above, as well as for a control sample, an untreated 22 mm by 22 mm micro cover glass plate. The samples were automatically evaluated by the KROSS Tensiometer a plurality of times, and the average of these plural readings is reported on the following table.

TABLE 4

| | E2 | E10 | E23 | E24 | E38 | E45 | E57 | E64 | E71 | E82 | E96 | Ctrl |
|---|---|---|---|---|---|---|---|---|---|---|---|---|
| 1 | 72.4 | 80.5 | 81.2 | 80.1 | 77.2 | 84.9 | 74.6 | 67.2 | 80.3 | 74.3 | 82.3 | |
| 2 | 75.0 | 76.2 | 83.8 | 82.2 | 79.8 | 82.2 | 76.3 | 65.2 | 77.5 | 70.5 | 81.5 | |
| 3 | 72.6 | 78.0 | 78.6 | 81.3 | 78.7 | 83.4 | 75.2 | 64.7 | 78.7 | 72.2 | 83.8 | |
| 4 | 71.7 | 80.5 | 82.7 | 87.0 | 77.1 | 77.8 | 75.6 | 65.1 | 77.8 | 71.4 | 82.4 | |
| 5 | 70.1 | 81.2 | 79.8 | 80.0 | 78.6 | 86.9 | 70.8 | 64.7 | 78.6 | 73.2 | 83.6 | |
| 6 | 73.2 | 84.5 | 80.3 | 86.3 | 76.5 | 84.3 | 74.3 | 63.1 | 76.3 | 73.3 | 83.5 | |
| 7 | 73.7 | 77.2 | 75.2 | 83.5 | 75.3 | 80.0 | 76.3 | 61.8 | 77.9 | 77.3 | 80.8 | |
| 8 | 78.0 | 77.9 | 75.6 | 80.5 | 77.1 | 80.5 | 74.3 | 61.6 | 77.5 | 74.2 | 83.2 | |
| 9 | 75.8 | 79.7 | 74.1 | 83.2 | 74.7 | 74.0 | 69.2 | 68.9 | 78.2 | 74.2 | 83.1 | |
| 10 | 76.8 | 80.6 | 80.2 | 80.6 | 79.3 | 87.1 | 75.8 | 69.0 | 79.3 | 74.2 | | |
| 11 | | 75.4 | | 79.0 | | | | 67.8 | | | | |
| Average | 73.9 | 79.2 | 79.2 | 82.2 | 77.4 | 82.1 | 74.2 | 65.4 | 78.2 | 73.5 | 82.7 | 54.5* |
| Advancing | | | | | | | | | | | | |
| Contact | | | | | | | | | | | | |
| Angle | | | | | | | | | | | | |

*average of ten replicates, each replicate having 6 runs.

The advancing contact angles for various compositions of the present invention indicate the presence of a hydrophobic film on the surface of the micro cover glass plate.

### Antimicrobial Efficacy

Several compositions of the present invention were evaluated for antimicrobial activity using the Biomek® 2000 Laboratory Automation Workstation together with the BioWorks Operating System (available from Beckman Coulter Inc., Fullerton, Calif.). The organism tested was Staphylococcus aureus at a concentration of 9 logs. The Biomek simulates a microbial reduction suspension test. One part of organism suspension (Staphylococcus aureus) is added to 9 parts of each of the samples listed in Table 5 in an appropriate container. Deionized water (DI H₂0) was used a control. The organism and sample are then mixed thoroughly for 15 seconds. Serial tenfold dilutions are carried out in a neutralizing broth. The diluted samples are then incubated for 24-48 hours at 35-37° C. Thereafter, surviving organisms are quantified and log reduction, as a measurement of organism survivors are calculated as follows:

Log Reduction=(Log Survivors/DI H₂O Control)−(Log Survivors/Sample)

The results of the antimicrobial testing are found in Table 5 below.

TABLE 5

| Sample | Log Reduction |
|---|---|
| E2 | 5.3 |
| E10 | 4.8 |
| E11 | 4.6 |
| E24 | 4.6 |
| E38 | 3.9 |
| E45 | 5.4 |
| E57 | 3.8 |
| E64 | 5.6 |
| E71 | 5.2 |
| E78 | 5.1 |
| E96 | 3.85 |

As may be seen from the results indicated above, the compositions according to the invention provide excellent cleaning benefits to hard surfaces, including hard surfaces with difficult to remove stains notwithstanding the low solids content of the inventive compositions. These advantages are further supplemented by the excellent antimicrobial efficacy of these compositions against known bacteria commonly found in bathroom, kitchen and other. Such advantages clearly illustrate the superior characteristics of the compositions, the cleaning and antimicrobial benefits attending its use which is not before known to the art.

1. A hard surface cleaning and disinfecting composition which comprises:
(a) at least one cationic surfactant having germicidal properties;
(b) a fluorosurfactant selected from the group of nonionic fluorosurfactants, cationic fluorosurfactants, perfluoroalkylethyl fluorosurfactants, and mixtures thereof;
(c) a film-forming polymer selected from the group consisting of
(3) polyvinylpyrrolidone,
(d) optionally, one or more detersive surfactants selected from carboxylate, nonionic, cationic and amphoteric surfactants;
(e) optionally, one or more organic solvents;
(f) water; and
optionally, one or more further conventional constituents such as: pH buffering agents, perfumes, perfume carriers, colorants, hydrotropes, viscosity modifying agents, further germicides, fungicides, anti-oxidants, and anti-corrosion agents.

2. The hard surface cleaning and disinfecting composition according to claim 1 which comprises both (d) one or more detersive surfactants selected from carboxylate, nonionic, cationic and amphoteric surfactants and (e) one or more organic solvents.

3. The hard surface cleaning and disinfecting composition according to claim 1 which is comprises (d) detersive surfactants selected from carboxylate, nonionic, cationic and amphoteric surfactants and which is characterized in being essentially free of (e) one or more organic solvents.

4. The hard surface cleaning and disinfecting composition according to claim 1 which is comprises (e) one or more organic solvents and is characterized as being essentially free of (d) detersive surfactants selected from carboxylate, nonionic, cationic and amphoteric surfactants.

5. The hard surface cleaning and disinfecting composition according to claim 1 which is characterized as being essentially free of (d) detersive surfactants selected from carboxylate, nonionic, cationic and amphoteric surfactants and being essentially free of (e) one or more organic solvents.

6. The hard surface cleaning and disinfecting composition according to claim 1 wherein (b) fluorosurfactant is selected from the group consisting of
CₙF₂ₙ₊₁SO₂N(C₂H₅)(CH₂CH₂O)ₙCH₃
wherein: n has a value of from 1-12, preferably from 4-12, most preferably 8;
x has a value of from 4-18, preferably from 4-10, most preferably 7;
RfCH₂CH₂O(CH₂CH₂O)ₓH
wherein Rf is F(CF₂CF₂)_{y} and
either x is 0 to about 15 and y is 1 to about 7, or
x is 0 to about 25 and y is 1 to about 9;
CₙF₂ₙ₊₁SO₂NHC₃H₆N⁺(CH₃)₃I⁻
wherein n-8;
CF₃—(CF₂)ₙ—(CH₂)ₘSCH₂CHOH—CH₂—N⁺R₁R₂R₃CI⁻
wherein: n is 5-9 and m is 2, and R₁, R₂ and R₃ are —CH₃;
CF₃—(CF₂)₅—CH₂—CH₂—S—CH₂—CH(OH)—CH₂—N(CH₃)₃⁺Cl⁻; 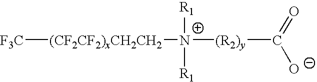
wherein:
each of R₁ and R₂ independently is C₁-C₆ alkyl or C₁-C₆ alkenyl group, preferably a C₁-C₃ alkyl group, particularly a methyl group;
x is an integer from 1-20; preferably is an integer from 8-12;
y is an integer from 1-20; preferably is an integer from 1-10; 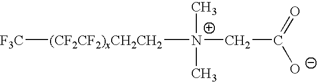
wherein: x has a value of 8-12; 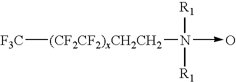
wherein:
R₁ is a C₁-C₆ alkyl or C₁-C₆ alkenyl group; and,
x is an integer from 1-20; preferably is an integer from 8-12; 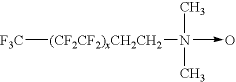
wherein: x has a value of 8-12; or 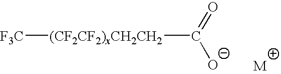
wherein: M is an alkali or alkaline earth metal counterion.

7. (canceled)

8. A process for the cleaning and sanitizing of a hard surface which comprises the step of providing the composition according to claim 1, and applying an effective amount of the composition to the hard surface requiring such treatment.

9. The hard surface cleaning and disinfecting composition according to claim 1 wherein the (a) at least one cationic surfactant having germicidal properties is one or more quaternary ammonium compounds or salts thereof which may be characterized by the general structural formula: 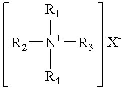
where at least one of R1, R2, R3 and R4 is a alkyl, aryl or alkylaryl substituent of from 6 to 26 carbon atoms which may be straight-chained or may be branched, the remaining substituents on the nitrogen atoms other than the above-mentioned alkyl substituents are hydrocarbons usually containing no more than 12 carbon atoms, and the counterion X may be any salt-forming anion which permits water solubility of the quaternary ammonium complex.

10. The hard surface cleaning and disinfecting composition according to claim 9 wherein the (a) at least one cationic surfactant having germicidal properties is one or more quaternary ammonium compounds or salts thereof which may be characterized by the general structural formula: 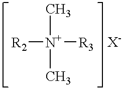
wherein R₂ and R₃ are the same or different C₈-C₁₂alkyl, or R₂ is C₁₂₋₁₆alkyl, C₈₋₁₈alkylethoxy, C₈₋₁₈alkylphenoxyethoxy and R₃ is benzyl, and X is a halide, for example chloride, bromide or iodide, or is a methosulfate anion.
